(19) United States
(12) Patent Application Publication
(10) Pub. No.: US 2008/0248343 A1
(43) Pub. Date: Oct. 9, 2008

(54) MICROFLUIDIC FUEL CELLS

(76) Inventors: Larry J. Markoski, Raleigh, NC (US); Dilip Natarajan, Cary, NC (US); Alex Primak, Morrisville, NC (US)

Correspondence Address: EVAN LAW GROUP LLC, 600 WEST JACKSON BLVD., SUITE 625, CHICAGO, IL, 60661, US

(21) Appl. No.: 12/061,349

(22) Filed: Apr. 2, 2008

Related U.S. Application Data
(60) Provisional application No. 60/909,681, filed on Apr. 2, 2007.

(51) Int. Cl. H01M 8/04; H01M 2/00

(52) U.S. Cl. 429/15; 429/34

(57) ABSTRACT

A fuel cell includes an anode, a cathode, a microfluidic channel contiguous with at least one of the anode and the cathode, and a single flowing electrolyte. The flowing electrolyte passes through the microfluidic channel. A method of generating electricity includes flowing the single electrolyte through the microfluidic channel, where a fuel is oxidized at the anode, an oxidant is reduced at the cathode, and the electrolyte comprises the fuel or the oxidant. The flowing electrolyte may pass through the microfluidic channel in a laminar flow.

### REFERENCE TO RELATED APPLICATIONS

This application claims the benefit of U.S. Provisional Application No. 60/909,681 entitled “Microfluidic Fuel Cells” filed Apr. 2, 2007, which is incorporated by reference in its entirety.

### BACKGROUND

Fuel cell technology shows great promise as an alternative energy source for numerous applications. Several types of fuel cells have been constructed, including polymer electrolyte membrane fuel cells, direct methanol fuel cells, alkaline fuel cells, phosphoric acid fuel cells, molten carbonate fuel cells, and solid oxide fuel cells. For a comparison of several fuel cell technologies, see Los Alamos National Laboratory monograph LA-UR-99-3231 entitled Fuel Cells: Green Power by Sharon Thomas and Marcia Zalbowitz.

FIG. 1 represents an example of a fuel cell 100, including a high surface area anode 110 including an anode catalyst 112, a high surface area cathode 120 including a cathode catalyst 122, and an electrolyte 130 between the anode and the cathode. The electrolyte may be a liquid electrolyte; it may be a solid electrolyte, such as a polymer electrolyte membrane (PEM); or it may be a liquid electrolyte contained within a host material, such as the electrolyte in a phosphoric acid fuel cell (PAFC).

In operation of the fuel cell 100, fuel in the gas and/or liquid phase is brought over the anode 110 where it is oxidized at the anode catalyst 112 to produce protons and electrons in the case of hydrogen fuel, or protons, electrons, and carbon dioxide in the case of an organic fuel. The electrons flow through an external circuit 140 to the cathode 120 where air, oxygen, or an aqueous oxidant (e.g., peroxide) is being fed. Protons produced at the anode 110 travel through electrolyte 130 to cathode 120, where oxygen is reduced in the presence of protons and electrons at cathode catalyst 122, producing water in the liquid and/or vapor state, depending on the operating temperature and conditions of the fuel cell.

Hydrogen and methanol have emerged as important fuels for fuel cells, particularly in mobile power (low energy) and transportation applications. The electrochemical half reactions for a hydrogen fuel cell are listed below.

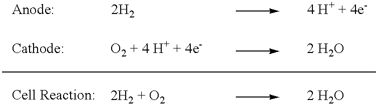

To avoid storage and transportation of hydrogen gas, the hydrogen can be produced by reformation of conventional hydrocarbon fuels. In contrast, direct liquid fuel cells (DLFCs) utilize liquid fuel directly, and do not require a preliminary reformation step of the fuel. As an example, the electrochemical half reactions for a Direct Methanol Fuel Cell (DMFC) are listed below.

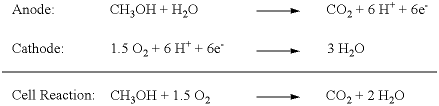

A key component in conventional fuel cells is a semi-permeable membrane, such as a solid polymer electrolyte membrane (PEM) that physically and electrically isolates the anode and cathode regions, while conducting protons (H⁺) through the membrane to complete the cell reaction. Typically, PEMs have finite life cycles due to their inherent chemical and thermal instabilities. Moreover, such membranes typically exhibit relatively poor mechanical properties at high temperatures and pressures, which can seriously limit their range of use.

In contrast, a laminar flow fuel cell (LFFC) can operate without a PEM between the anode and cathode. An LFFC uses the laminar flow properties of a microfluidic liquid stream to deliver a reagent to one or both electrodes of a fuel cell. In one example of an LFFC, fuel and oxidant streams flow through a microfluidic channel in laminar flow, such that fluid mixing and fuel crossover is minimized. In this example, an induced dynamic conducting interface (IDCI) is present between the two streams, replacing the PEM of a conventional fuel cell. The IDCI can maintain concentration gradients over considerable flow distances and residence times, depending on the dissolved species and the dimensions of the flow channel. IDCI-based LFFC systems are described, for example, in U.S. Pat. No. 6,713,206 to Markoski et al., in U.S. Pat. No. 7,252,898 to Markoski et al., and in U.S. Patent Application Publication 2006/0088744 to Markoski et al.

One challenge faced in developing fuel cells is to reduce their physical dimensions and simplify their operation without sacrificing their electrochemical performance. It would be desirable to provide a fuel cell that has the advantages and electrochemical performance of an IDCI-based LFFC, but that does not need the size and external components necessary to manage two distinct fluids.

### SUMMARY

In one aspect, the invention provides a fuel cell that includes an anode, a cathode, a microfluidic channel contiguous with at least one of the anode and the cathode, and a single flowing electrolyte. The flowing electrolyte passes through the microfluidic channel.

In another aspect, the invention provides a method of generating electricity that includes flowing a single electrolyte through a microfluidic channel. The microfluidic channel is in a fuel cell that includes an anode and a cathode, and the microfluidic channel is contiguous with at least one of an anode and a cathode. A fuel is oxidized at the anode, an oxidant is reduced at the cathode, and the electrolyte includes the fuel or the oxidant.

In another aspect, the invention provides a fuel cell that includes a first electrode, a second electrode, and a single flowing electrolyte in contact with at least one of the first and second electrodes. Ions travel from the first electrode to the second electrode without traversing a membrane. A current density of at least 0.1 mA/cm² is produced.

In another aspect, the invention provides a fuel cell stack that includes a plurality of fuel cells including at least one of the above fuel cells.

In another aspect, the invention provides a power supply device that includes at least one of the above fuel cells.

In another aspect, the invention provides an electronic device that includes the power supply device.

In another aspect, the invention provides a fuel cell including a first electrode, a second electrode, and a channel contiguous with at least a portion of the first and the second electrodes; such that when a first liquid is contacted with the first electrode, a second liquid is contacted with the second electrode, and the first and the second liquids flow through the channel, a multistream laminar flow is established between the first and the second liquids, and a current density of at least 0.1 mA/cm² is produced. In this aspect, the fuel cell is improved by replacing the first and second liquids with a single flowing electrolyte in contact with at least one of the first and second electrodes.

These aspects may include a single flowing electrolyte that passes through the microfluidic channel in a laminar flow.

The following definitions are included to provide a clear and consistent understanding of the specification and claims.

The term “single flowing electrolyte” means an electrolyte having a homogeneous composition prior to contact with an anode and/or a cathode. A single flowing electrolyte excludes dual fluid electrolytes in which two different fluids are introduced into a single channel, or into two channels separated by a porous separator.

The term “microfluidic channel” means a channel having a dimension less than 500 micrometers.

The term “laminar flow” means the flow of a liquid with a Reynolds number less than 2,300. The Reynolds number (Rₑ) is a dimensionless quantity defined as the ratio of inertial forces to viscous forces, and can be expressed as:

Rₑ=(ρvL)/μ

where L is the characteristic length in meters, ρ is the density of the fluid (g/cm³), v is the linear velocity (m/s), and μ is the viscosity of the fluid (g/(s cm)).

The term “gas diffusion electrode” (GDE) means an electrically conducting porous material.

The term “hydraulic barrier” means a fluid-tight material that can maintain a concentration gradient between two fluids on either side of the barrier. The two fluids may be two gases, two liquids, or a gas and a liquid. A hydraulic barrier includes a liquid-tight material that can maintain a concentration gradient between two liquids of differing concentration on either side of the barrier. A hydraulic barrier may permit a net transport of molecules between the two fluids, but prevents mixing of the bulk of the two fluids.

The term “convective contact” means that a material is in direct contact with a flowing fluid. If an electrode having a catalyst is in convective with a flowing fluid, then the catalyst and the fluid are in direct contact, without an intervening layer or diffusion medium.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 is a schematic representation of a fuel cell.

FIG. 2 is a schematic representation of a fuel cell including a single flowing electrolyte that passes through a microfluidic channel.

FIG. 3 is a schematic representation of a fuel cell having a microfluidic channel contiguous with both the anode and the cathode.

FIG. 4 is a schematic representation of a fuel cell having a microfluidic channel contiguous with both the anode and the cathode, where the fuel is in the single flowing electrolyte in the channel.

FIG. 5 is a schematic representation of a fuel cell having a microfluidic channel contiguous with both the anode and the cathode, where the oxidant is in the single flowing electrolyte in the channel.

FIG. 6 is a schematic representation of a fuel cell having a microfluidic channel contiguous with the anode only.

FIG. 7 is a schematic representation of a fuel cell having a microfluidic channel contiguous with the anode only, where the fuel is in the single flowing electrolyte in the channel.

FIG. 8 is a schematic representation of a fuel cell having a microfluidic channel contiguous with only one of the anode or the cathode, where either the fuel or the oxidant is in the single flowing electrolyte in the channel.

FIG. 9 is a schematic representation of a fuel cell having a microfluidic channel contiguous with the cathode only.

FIG. 10 is a schematic representation of a fuel cell having a microfluidic channel contiguous with the cathode only, where the oxidant is in the single flowing electrolyte in the channel.

FIG. 11 is a representation of a fuel cell including a single flowing electrolyte that passes through a microfluidic channel.

FIG. 11A is a representation of the cathode plate 1160 of FIG. 11.

FIG. 12 is a representation of a fuel cell stack including a single flowing electrolyte that passes through a microfluidic channel.

FIG. 13 is a representation of an anode endplate for a fuel cell stack.

FIG. 14 is a representation of a cathode endplate for a fuel cell stack.

FIG. 15 is a representation of an electrode assembly for a fuel cell stack.

FIG. 16 is a schematic representation of a power supply device.

FIG. 17 is a graph of cell voltage over time for a fuel cell having a single flowing electrolyte and for a fuel cell stack having two flowing electrolytes.

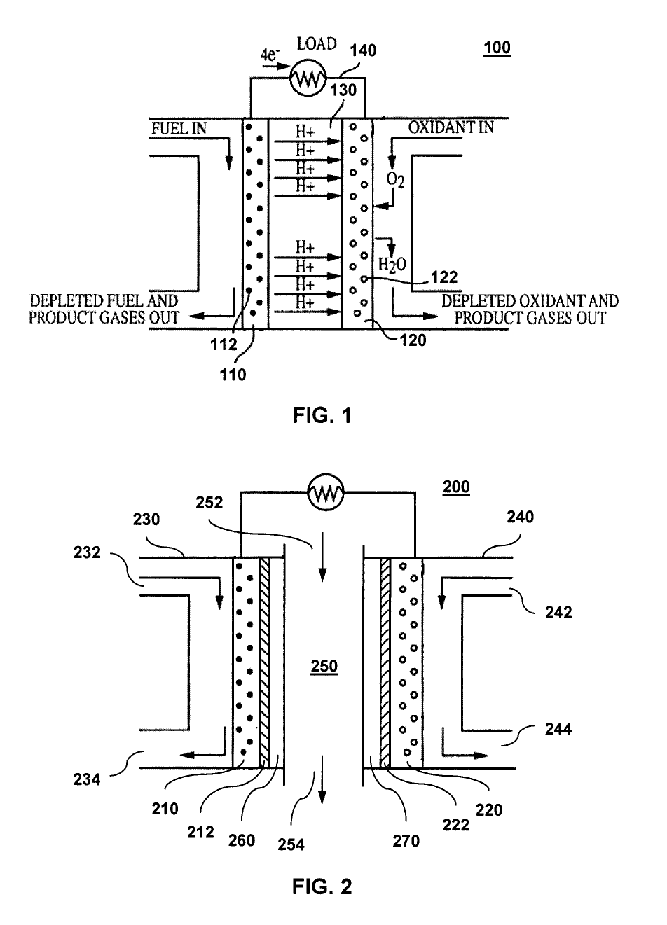

### DETAILED DESCRIPTION

The present invention makes use of the discovery that a microfluidic fuel cell can provide advantages of an IDCI-based LFFC, while including only a single flowing electrolyte. The use of one flowing electrolyte in a microfluidic channel, instead of two flowing electrolytes, may provide additional advantages, such as increased simplicity of the fuel cell and smaller physical dimensions for the cell.

FIG. 2 represents an example of a fuel cell 200 that includes an anode 210, a cathode 220, a microfluidic channel contiguous with at least one of the anode and the cathode, and a single flowing electrolyte. Cell 200 can be configured in a variety of ways, and may include optional fuel channel 230, optional oxidant channel 240, optional central channel 250, and/or optional stationary electrolytes 260 and/or 270. Optional fuel channel 230 includes a fuel inlet 232 and an optional fuel outlet 234. Optional oxidant channel 240 includes an oxidant inlet 242 and an optional oxidant outlet 244. Optional central channel 250 includes an inlet 252 and an outlet 254. The microfluidic channel contiguous with at least one of the anode and the cathode is one of channels 230, 240 or 250. During operation, the single flowing electrolyte passes through the microfluidic channel, preferably in a laminar flow.

The anode 210 has first and second surfaces. The first surface is separated from the cathode 220 by an electrolyte, which includes the single flowing electrolyte and/or a stationary electrolyte. Optional hydraulic barrier 212 may be present at the first surface. The second surface of anode 210 may be in contact with optional fuel channel 230. The fuel for reaction at the anode is provided in the optional fuel channel 230 and/or the optional central channel 250.

The anode 210 includes an anode catalyst, so that a half cell reaction may take place at the anode. The half cell reaction at the anode in a fuel cell typically produces electrons and protons. The electrons produced provide an electric potential in a circuit connected to the fuel cell. Examples of anode catalysts include platinum, and combinations of platinum with another metal, such as ruthenium, tin, osmium or nickel. The anode also may include a porous conductor, such as a gas diffusion electrode (GDE).

The fuel may be any substance that can be oxidized to a higher oxidation state by the anode catalyst. Examples of fuels include hydrogen, oxidizable organic molecules, ferrous sulfate, ferrous chloride, and sulfur. Oxidizable organic molecules that may be used as fuels in a fuel cell include organic molecules having only one carbon atom. Oxidizable organic molecules that may be used as fuels in a fuel cell include organic molecules having two or more carbons but not having adjacent alkyl groups, and where all carbons are either part of a methyl group or are partially oxidized. Examples of such oxidizable organic molecules include methanol, formaldehyde, formic acid, glycerol, ethanol, isopropyl alcohol, ethylene glycol and formic and oxalic esters thereof, oxalic acid, glyoxylic acid and methyl esters thereof, glyoxylic aldehyde, methyl formate, dimethyl oxalate, and mixtures thereof. Preferred fuels include gaseous hydrogen, gaseous pure methanol, liquid pure methanol and aqueous mixtures of methanol, including mixtures of methanol and an electrolyte.

In an example of fuel cell 200, the anode 210 is in contact with fuel channel 230, and the fuel is supplied to the anode through the fuel channel, in the single flowing electrolyte. In this example, the optional central channel is not present, and the anode and cathode are separated by stationary electrolyte 260 or 270. In another example of fuel cell 200, fuel channel 230 is not present, and the fuel is supplied to the anode through the central channel 250, in the single flowing electrolyte.

In yet another example of fuel cell 200, the anode 210 is in contact with fuel channel 230, and the fuel is supplied to the anode as a stream of gaseous hydrogen or methanol. For a fuel channel 230 having a fuel outlet 234, maintaining an adequate pressure at the outlet may provide for essentially one-way diffusion of fuel through the GDE of anode 210. When pure hydrogen or methanol is used as the gaseous fuel, no depleted fuel is formed. Thus, a fuel outlet may be unnecessary, and the fuel channel 230 may be closed off or may terminate near the end of anode 210. However, in this example, an outlet 234 for the fuel channel may be useful to remove gaseous reaction products, such as CO₂.

The cathode 220 has first and second surfaces. The first surface is separated from the anode 210 by an electrolyte, which includes the single flowing electrolyte and/or a stationary electrolyte. Optional hydraulic barrier 222 may be present at the first surface. The second surface of cathode 220 may be in contact with optional oxidant channel 240. The oxidant for reaction at the cathode is provided in the optional oxidant channel 240 and/or the optional central channel 250.

The cathode 220 includes a cathode catalyst, so that a complementary half cell reaction may take place at the cathode. The half cell reaction at the cathode in a fuel cell typically is a reaction between an oxidant and ions from the electrolyte, such as H⁺ ions. Examples of cathode catalysts include platinum, and combinations of platinum with another metal, such as cobalt, nickel or iron. The cathode also may include a porous conductor, such as a GDE. In one example, the GDE may include a porous carbon substrate, such as teflonized (0-50%) carbon paper of 50-250 micrometer (micron) thickness. A specific example of this type of GDE is Sigracet® GDL 24 BC, available from SGL Carbon AG (Wiesbaden, Germany).

The oxidant may be any substance that can be reduced to a lower oxidation state by the cathode catalyst. Examples of oxidants include molecular oxygen (O₂), ozone, hydrogen peroxide, permanganate salts, manganese oxide, fluorine, chlorine, bromine, and iodine. The oxidant may be present as a gas or dissolved in a liquid. Preferably the oxidant is gaseous oxygen, which is preferably present in a flow of air.

In an example of fuel cell 200, the cathode 220 is in contact with oxidant channel 240, and the oxidant is supplied to the cathode through the oxidant channel, in the single flowing electrolyte. In this example, the optional central channel is not present, and the anode and cathode are separated by stationary electrolyte 260 or 270. In another example of fuel cell 200, oxidant channel 240 is not present. In this example, oxidant is in the single flowing electrolyte, which flows in central channel 250.

In yet another example of fuel cell 200, the cathode 220 is in contact with oxidant channel 240. In this example, the oxidant supplied to the cathode may be a stream of air or gaseous oxygen. For an oxidant channel 240 having an oxidant outlet 244, maintaining an adequate pressure at the outlet may provide for essentially one-way diffusion of oxidant through the GDE of cathode 220. When pure oxygen is used as the gaseous oxidant, no depleted oxidant is formed. Thus, an oxidant outlet may be unnecessary, and the oxidant channel 240 may be closed off or may terminate near the end of cathode 220. However, in this example, an outlet 244 for the oxidant channel may be useful to remove reaction products, such as water.

If the oxidant is introduced to the cathode in the vapor phase, the cathode 220 may include a GDE, and the electroactive area of the cathode preferably is protected from direct bulk contact with liquid electrolyte present in the fuel cell. If a surface of the cathode is in contact with a liquid electrolyte, that surface preferably blocks the bulk hydraulic flow of liquid electrolyte into the cathode but permits transport of water and ions between the liquid electrolyte and the cathode. The transport of ions provides the reactant to the cathode that is necessary to complete the cell reaction with the oxidant. When solvated protons from the anode are transported to the cathode, an electro-osmotic drag may occur, providing a driving force for water to accumulate within the cathode structure. Conversely, water produced by the reduction reaction at the cathode also may back-transport toward the anode, creating a force in opposition to electro-osmotic drag. The presence of a liquid electrolyte in the fuel cell may reduce the rate of electro-osmotic drag and/or increase the rate of transport of liquid water away from the cathode.

For vapor phase oxidants, it is desirable for the oxidant pressure to be low, so that a compressor is not required for the oxidant. Compressors can be highly parasitic of the power generated by the fuel cell. Preferably the oxidant pressure is no greater than 15 pounds per square inch (psi; 0.10 MPa). More preferably the oxidant pressure is no greater than 10 psi (0.07 MPa), and more preferably is no greater than 5 psi (0.035 MPa). The oxidant flow rate may be expressed in terms of stoichiometric units, referred to herein as a “stoich”. A “stoich” is defined as the volumetric flow rate of oxidant required to supply a stoichiometric amount of the oxidant to the cathode. This flow rate increases as the current density of the cell increases and is thus dependent on the current density of the cell. Preferably the flow rate of the oxidant is from 1 to 10 stoich, more preferably from 1.2 to 5 stoich, and more preferably from 1.5 to 3 stoich.

In one example, cathode 220 includes a GDE and a catalyst, where the catalyst forms a fluid-tight layer at the surface of the GDE. In this example, it is preferable for the portion of the catalyst in contact with the electrolyte to be hydrophilic, so as to facilitate the transport of water through the fluid-tight layer. Such a fluid-tight catalyst layer may serve as a hydraulic barrier. In another example, cathode 220 includes a distinct hydraulic barrier 222 between the GDE and the liquid electrolyte.

Anode 210 and cathode 220 independently may include an optional hydraulic barrier 212 or 222, respectively. The hydraulic barrier can maintain a concentration gradient between two fluids on either side of the barrier. Preferably the primary mode of transport between the two fluids is by diffusion through the barrier. Preferably an optional hydraulic barrier is hydrophilic, so as to facilitate the transport of water and electrolyte through the barrier to the catalyst.

Examples of materials for an optional hydraulic barrier 212 or 222 include inorganic networks, such as porous ceramics, zeolites and catalyst layers; organic networks, such as carbon tubes and crosslinked gels; membranes, such as microfiltration membranes, ultrafiltration membranes, nanofiltration membranes and ion-exchange membranes; and combinations of inorganic networks, organic networks and/or membranes, such as inorganic/organic composites. Preferably the hydraulic barrier has a total thickness of 100 microns or less. If the hydraulic barrier is too thick or too hydrophobic to maintain proton and water transport rates in either direction, the electrode can suffer resistive losses that inhibit performance of the fuel cell.

In one example, an optional hydraulic barrier 212 or 222 includes a membrane, such as a permeable polymeric material that restricts the transport of at least one chemical substance. See, for example, Baker, R. W. “Membrane Technology,” Encyclopedia of Polymer Science and Technology, Vol. 3, pp. 184-248 (2005). For example, the hydraulic barrier may include a membrane separator that is typically used between the electrodes of a fuel cell, a battery, or a redox flow cell. These membrane separators include polymer electrolyte membranes (PEM), which may be cation-exchange membranes or anion-exchange membranes. Examples of PEMs that may be used as a hydraulic barrier include polymers and copolymers derived at least in part from perfluorosulfonic acid, such as Nafion® (DuPont; Wilmington, Del.), Aciplex® S1004 (Asahi Chemical Industry Company; Tokyo, Japan), XUS-13204 (Dow Chemical Company; Midland, Mich.), and GORE-SELECT® (W.L. Gore; Elkton, Md.). These membrane separators also include non-ionic polymers, such as expanded poly(tetrafluoroethylene) (i.e. GORE-TEX®, W.L. Gore); expanded polyethylene; aromatic polymers such as polyphenylene oxide (PPO), polyphenylene sulfide (PPS), polyphenylene sulfone, poly(etheretherketone) (PEEK), polybenzimidazole (PBI), polybenzazoles, polybenzothiazoles, polyimides, and fluorinated polystyrene; and inorganic-organic polymers, such as polyphosphazenes and poly(phenylsiloxanes). Non-ionic membrane separators typically serve as a matrix to hold the electrolyte between the two electrodes, and may be doped with acid electrolyte to become proton conducting. The acid electrolyte may be a liquid electrolyte or a solid electrolyte, such as a polymer electrolyte. These non-ionic membrane separators may be functionalized with acid groups or ammonium groups to form cation-exchange membranes or anion-exchange membranes.

In another example, an optional hydraulic barrier 212 or 222 includes a membrane separator onto which is bonded a catalyst, such as 4 mg/cm² Pt black. Unlike the membrane separator between the anode and cathode of a PEM fuel cell, which has catalyst on both sides of the membrane, this hydraulic barrier has catalyst on only one side of the layer.

In another example, an optional hydraulic barrier 212 or 222 includes a hydrogel, which is a polymeric network that has been expanded with a liquid. For example, a hydraulic barrier may include a polymeric network that has been expanded by an aqueous liquid, such as water or an electrolyte. In this example, the polymer network is insoluble in the aqueous liquid, and swells when contacted with the aqueous liquid. Preferably the polymer network is chemically resistant to the aqueous liquid and is thermally stable at the temperatures at which the cell may be stored and operated. Preferably the polymer network is insoluble in, and chemically resistant to, any other liquids that may contact the network during storage or operation of the fuel cell, such as the single flowing electrolyte.

For an optional hydraulic barrier 212 or 222 that includes a hydrogel, the polymeric network of the hydrogel includes a polymer having chemical or physical crosslinks between the polymer chains. The polymer may be neutral, or it may have cationic and/or anionic groups bound to the polymer. Examples of neutral polymers include poly(vinyl alcohol) (PVA), expanded poly(tetrafluoroethylene) (ePTFE), expanded polyethylene; aromatic polymers such as polyphenylene oxide (PPO), polyphenylene sulfide (PPS), polyphenylene sulfone, poly(etheretherketone) (PEEK), polybenzimidazole (PBI), polybenzazoles, polybenzothiazoles, polyimides, and fluorinated polystyrene; and inorganic-organic polymers, such as polyphosphazenes and poly(phenylsiloxanes). Examples of polymers having cationic groups bound to the polymer include polymers and copolymers including quaternary ammonium groups. For example, a polymer or copolymer may include monomeric units derived from acryloxyethyltrimethyl ammonium chloride, N,N-diallyldimethylammonium chloride, (3-acrylamidopropyl)trimethylammonium chloride, or vinyl pyridine (where the pyridine group has been quaternized). Examples of polymers having anionic groups bound to the polymer include polymers and copolymers derived at least in part from perfluorosulfonic acid, such as Nafion®, and include polymers and copolymers including carboxylate, sulfonate, phosphate and/or nitrate groups.

In fuel cell 200, the single flowing electrolyte passes through the cell in a microfluidic channel that is contiguous with at least one of the anode 210 and the cathode 220. The single flowing electrolyte may pass through the cell in more than one microfluidic channel. For example, the single flowing electrolyte may be delivered to an area near the anode and/or the cathode of the cell in a manifold, and then distributed into multiple microfluidic channels that traverse the electrode(s). Each of these microfluidic channels has a dimension less than 500 micrometers. Preferably each channel has a dimension less than 400 micrometers, more preferably less than 300 micrometers, more preferably less than 250 micrometers, more preferably less than 200 micrometers, more preferably less than 100 micrometers, more preferably less than 75 micrometers, more preferably less than 50 micrometers, more preferably less than 25 micrometers, and more preferably less than 10 micrometers.

For a single flowing electrolyte that passes through the cell in more than one microfluidic channel, the flow rate in an individual channel may be from 0.01 milliliters per minute (mL/min) to 10 mL/min. Preferably the flow rate of the single flowing electrolyte is from 0.1 to 1.0 mL/min, and more preferably is from 0.2 to 0.6 mL/min. The flow rate of the single flowing electrolyte may also be expressed in units such as centimeters per minute (cm/min). Preferably the flow rate of the single flowing electrolyte is at least 10 cm/min, more preferably at least 50 cm/min, and more preferably at least 100 cm/min. Preferably the single flowing electrolyte is transported in an individual channel at a rate of from 10 to 1,000 cm/min, more preferably from 50 to 500 cm/min, and more preferably from 100 to 300 cm/min.

The single flowing electrolyte preferably passes through the microfluidic channel in a laminar flow. The term “laminar flow” means the flow of a liquid with a Reynolds number less than 2,300. The Reynolds number (Rₑ) is a dimensionless quantity defined as the ratio of inertial forces to viscous forces, and can be expressed as:

Rₑ=(ρvL)/μ

where L is the characteristic length in meters, ρ is the density of the fluid (g/cm³), V is the linear velocity (m/s), and μ is the viscosity of the fluid (g/(s cm)). Laminar flow of the single flowing electrolyte may include flow of the electrolyte in a microfluidic channel together with a gaseous phase in the channel, such as a phase containing a gaseous reaction product, such as CO₂.

The optional stationary electrolytes 260 and 270 may have flow rates of from zero to a rate that is one order of magnitude smaller than the flow rate of the single flowing electrolyte. A stationary electrolyte may be a liquid that is sealed in the cell. A stationary electrolyte may be in a hydrogel. For example, an optional stationary electrolyte 260 or 270 may be the liquid that expands the polymeric network of a hydrogel. In this example, the polymer network is insoluble in the stationary electrolyte, and swells when contacted with the stationary electrolyte. Preferably the polymer network is chemically resistant to the stationary electrolyte and is thermally stable at the temperatures at which the cell may be stored and operated. Preferably the polymer network is insoluble in, and chemically resistant to, any other liquids that may contact the network during storage or operation of the fuel cell. The polymeric network includes a polymer having chemical or physical crosslinks between the polymer chains. The polymer may be neutral, or it may have cationic and/or anionic groups bound to the polymer.

The single flowing electrolyte and optional stationary electrolytes 260 and 270 independently may include any aqueous mixture of ions. A liquid electrolyte, whether flowing or stationary, is characterized by an osmotic pressure (Π), defined as:

Π=(solute concentration)×(number of atoms or ions in solute)×R×T

where R is the universal gas constant in units of kPa·m³/mol·Kelvin, T is the temperature in units of Kelvin, and the solute concentration is in units of kmol/m³, giving units of osmotic pressure in terms of kPa. Osmotic pressure of the liquid electrolyte can be measured by freezing point depression osmometry or vapor pressure osmometry, which may be carried out on a commercially available osmometer, such as those available from Advanced Instruments, Inc. (Norwood, Mass.) or from KNAUER ASI (Franklin, Mass.). Preferably the liquid electrolyte has an osmotic pressure of at least 1.2 megaPascals (MPa). More preferably the liquid electrolyte has an osmotic pressure of at least 2.5 MPa, more preferably of at least 3.5 MPa, more preferably of at least 10 MPa, more preferably of at least 15 MPa, more preferably of at least 20 MPa, and more preferably of at least 25 MPa. Preferably the liquid electrolyte has an osmotic pressure from 1.2 to 70 MPa, more preferably from 2.5 to 50 MPa, more preferably from 3.5 to 40 MPa.

Preferably the liquid electrolyte includes a protic acid. Examples of protic acids include hydrochloric acid (HCl), chloric acid (HClO₃), perchloric acid (HClO₄), hydroiodic acid (HI), hydrobromic acid (HBr), nitric acid (HNO₃), nitrous acid (HNO₂), phosphoric acid (H₃PO₄), sulfuric acid (H₂SO₄), sulfurous acid (H₂SO₃), trifluoromethanesulfonic acid (triflic acid, CF₃SO₃H) and combinations. More preferably the liquid electrolyte includes sulfuric acid. The liquid electrolyte may also contain non-acidic salts, such as halide, nitrate, sulfate, or triflate salts of alkali metals and alkaline earth metals or combinations.

In one example, the single flowing electrolyte and optional stationary electrolytes 260 and 270 independently may include sulfuric acid at a concentration of at least 0.1 moles per Liter (M). Preferred electrolytes include sulfuric acid at a concentration of at least 0.2 M, more preferably at least 0.25 M, more preferably at least 0.3 M, more preferably at least 0.4 M, more preferably at least 0.5 M, more preferably at least 1.0 M, more preferably at least 1.5 M, more preferably at least 3.0 M, more preferably at least 4.0 M, and more preferably at least 5.0 M. Preferred electrolytes include sulfuric acid at a concentration of from 0.1 to 9.0 M, more preferably from 0.25 to 9.0 M, more preferably from 0.5 to 7.0 M, more preferably from 0.75 M to 5.0 M, and more preferably from 1.0 to 3.0 M. The osmotic pressure of a liquid electrolyte including a protic acid may be further increased by the addition of non-acidic salts.

During operation of fuel cell 200, the liquid electrolyte in contact with the cathode 220 preferably has an osmotic pressure that is greater than the osmotic pressure of the liquid water produced and/or accumulating at the cathode. This difference in osmotic pressure imposes a fluid pressure that may be greater than, and in a direction opposite to, the electro-osmotic drag typically produced in a fuel cell. Thus, there is a driving force for transport of water from the cathode into the electrolyte, optionally by way of hydraulic barrier 222. Rather than water building up at the cathode at a rate greater than the rate at which it can be removed by an oxidant gas flow, water at the cathode may be transported by osmosis into the liquid electrolyte. Excess water may be at least partially recovered, and may be recycled back to the anode.

Preferably the difference between the osmotic pressure of the water at the cathode 220 and the osmotic pressure of the flowing and/or stationary electrolytes independently is at least 1 MPa. More preferably the difference between the osmotic pressure is at least 1.2 MPa, more preferably is at least 2.5 MPa, more preferably is at least 3.5 MPa, more preferably is at least 10 MPa, more preferably is at least 15 MPa, more preferably is at least 20 MPa, and more preferably is at least 25 MPa. Preferably the difference between the osmotic pressure of the water at the cathode and the osmotic pressure of the flowing and/or stationary electrolytes is from 1 to 70 MPa. More preferably the difference between the osmotic pressure is from 1.2 to 70 MPa, more preferably from 2.5 to 50 MPa, and more preferably from 3.5 to 40 MPa.

Preferably the fluid pressure created in opposition to the electro-osmotic drag is not of a magnitude that would prevent the transport of solvated ions through optional hydraulic barrier 222 toward the cathode 220. This fluid pressure is related to the difference in osmotic pressure, which is dependent on the osmotic pressures of the flowing and/or stationary electrolytes and of the liquid water within the catalyst layer. Thus, adequate ion flux to maintain the reaction at the cathode can be ensured by controlling the concentration of the electrolyte(s) and the water transport capabilities of the optional hydraulic barrier. Preferably the electrolyte can act as a buffer, so that fluctuations in the water content of the electrolyte do not cause drastic changes in the osmotic pressure of the electrolyte. In one example, the volume of electrolyte in a holding chamber may be such that the electrolyte volume can change until the osmotic pressure of the electrolyte is great enough to recover the requisite product water to operate at water neutral conditions.

Fuel cell 200 may further include an optional porous separator between the anode and the cathode. A porous separator may be present between optional stationary electrolytes 260 and 270, or between a stationary electrolyte and central channel 250. The porous separator can keep stationary and/or flowing electrolytes separate without interfering significantly with ion transport between the liquids. The porous separator preferably is hydrophilic, so the fluid within the electrolytes is drawn into the pores by capillary action. The liquids on either side of the separator are thus in direct contact, allowing ion transport between the two liquids. When the pores are small and the total area of the pores is a small percentage of the total area of the porous separator, mass transfer of fluid from one liquid to the other is very small, even if there is a significant difference in pressure between the liquids and across the separator. This lack of mass transfer may provide for a decrease in fuel crossover. Examples of porous separators and their use in electrochemical cells are disclosed in U.S. Patent Application Publication 2006/0088744 to Markoski et al.

Fuel cell 200 may further include proton-conducting nanoparticles between the cathode and the anode. As described in U.S. Patent Application Publication 2008/0070083 to Markoski et al., incorporation of proton-conducting metal nanoparticles, such as palladium nanoparticles, between the cathode and the anode may provide for a decrease in fuel crossover, while maintaining acceptable levels of proton conduction. The proton-conducting metal nanoparticles may be present in a mixture with a matrix material, and the properties of the fuel cell may be adjusted by changing the type of matrix material and/or the ratio of nanoparticles to the matrix material.

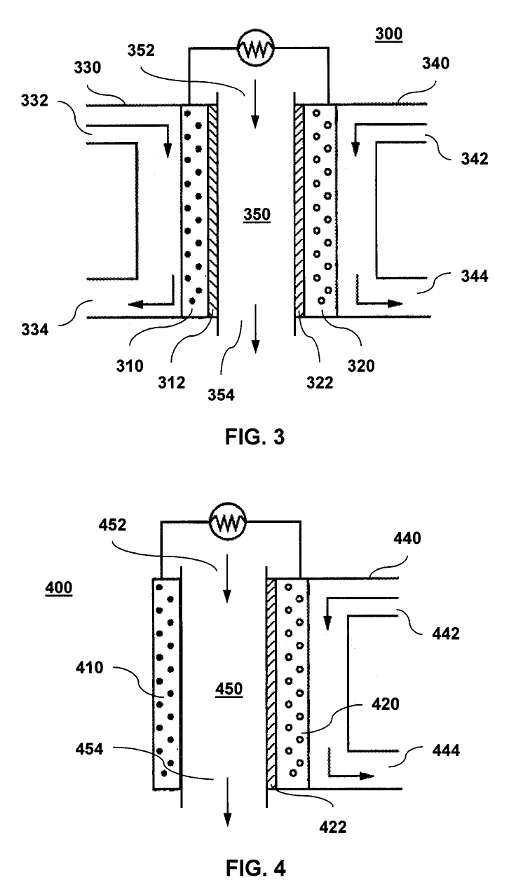

FIG. 3 represents an example of a fuel cell 300 that includes an anode 310, a cathode 320, a microfluidic channel 350 contiguous with both the anode and the cathode, and a single flowing electrolyte in the microfluidic channel. The anode 310 may include optional hydraulic barrier 312, and may be in contact with optional fuel channel 330, which includes a fuel inlet 332 and an optional fuel outlet 334. The cathode 320 may include optional hydraulic barrier 322, and may be in contact with optional oxidant channel 340, which includes an oxidant inlet 342 and an optional oxidant outlet 344. Microfluidic channel 350 includes an electrolyte inlet 352 and an electrolyte outlet 354. During operation, the single flowing electrolyte passes through the microfluidic channel 350, preferably in a laminar flow.

In one example, cell 300 includes both the fuel channel 330 and the oxidant channel 340. The single flowing electrolyte in the microfluidic channel 350 may include either a fuel or an oxidant, or it may include neither reactant. In this example, both anode 310 and cathode 320 include a GDE, and each is supplied with a gaseous stream that includes their respective reactant. For example, a stream of hydrogen gas or methanol gas may flow through fuel channel 330, and a stream of oxygen gas or air may flow through oxidant channel 340. If both reactants are supplied as gases, the anode and cathode each preferably include the hydraulic barrier 312 or 322.

In another example, cell 300 includes a fuel channel 330, and the single flowing electrolyte in the microfluidic channel 350 includes an oxidant. In this example, the anode includes a GDE, optionally includes a hydraulic barrier, and is supplied with a gaseous fuel through the fuel channel. In another example, cell 300 includes an oxidant channel 340, and the single flowing electrolyte in the microfluidic channel 350 includes a fuel. In this example, the cathode includes a GDE, optionally includes a hydraulic barrier, and is supplied with a gaseous oxidant through the oxidant channel.

FIG. 4 represents an example of a fuel cell 400 that includes an anode 410, a cathode 420, a microfluidic channel 450 contiguous with both the anode an the cathode, and a single flowing electrolyte in the microfluidic channel, where the flowing electrolyte in the microfluidic channel includes a fuel. Microfluidic channel 450 includes an electrolyte inlet 452 and an electrolyte outlet 454. During operation, the single flowing electrolyte passes through the channel 450, preferably in a laminar flow. The anode 410 is in convective contact with the fuel. The cathode 420 includes a GDE and a cathode catalyst, and is in contact with oxidant channel 440, which includes an oxidant inlet 442 and an optional oxidant outlet 444. The cathode 420 may include optional hydraulic barrier 422 contiguous with the microfluidic channel. The optional hydraulic barrier may include the cathode catalyst, or it may be positioned between the cathode catalyst and the microfluidic channel 450.

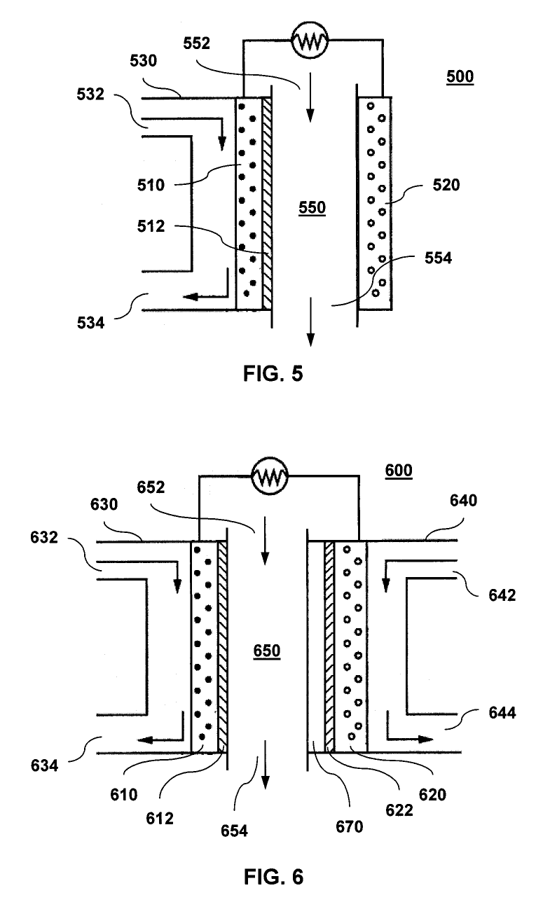

FIG. 5 represents an example of a fuel cell 500 that includes an anode 510, a cathode 520, a microfluidic channel 550 contiguous with both the anode an the cathode, and a single flowing electrolyte in the microfluidic channel, where the flowing electrolyte in the microfluidic channel includes an oxidant. Microfluidic channel 550 includes an electrolyte inlet 552 and an electrolyte outlet 554. During operation, the single flowing electrolyte passes through the channel 550, preferably in a laminar flow. The cathode 520 is in convective contact with the oxidant. The anode 510 includes a GDE and an anode catalyst, and is in contact with fuel channel 530, which includes a fuel inlet 532 and an optional fuel outlet 534. The anode 510 may include optional hydraulic barrier 512 contiguous with the microfluidic channel. The optional hydraulic barrier may include the anode catalyst, or it may be positioned between the anode catalyst and the microfluidic channel 550.

FIG. 6 represents an example of a fuel cell 600 that includes an anode 610, a cathode 620 including a GDE, an oxidant channel 640, a stationary electrolyte 670 between the anode and the cathode, a microfluidic channel contiguous with the anode only, and a single flowing electrolyte including a fuel. The anode 610 may include optional hydraulic barrier 612, and the cathode 620 may include optional hydraulic barrier 622. The oxidant channel 640 includes an oxidant inlet 642 and an optional oxidant outlet 644. Cell 600 can be configured in a variety of ways, and may include optional fuel channel 630, and/or optional central channel 650. Optional fuel channel 630 includes a fuel inlet 632 and an optional fuel outlet 634. Optional central channel 650 includes an electrolyte inlet 652 and an electrolyte outlet 654. The microfluidic channel contiguous with the anode only is one of channels 630 or 650. During operation, the single flowing electrolyte passes through the microfluidic channel, preferably in a laminar flow.

In one example, cell 600 includes the central channel 650, and the stationary electrolyte 670 is between the central channel and the cathode 620. In this example, the central channel 650 is the microfluidic channel. In another example, cell 600 includes the fuel channel 630, and the stationary electrolyte 670 is contiguous with the anode 610 and the cathode 620. In this example, the fuel channel 630 is the microfluidic channel.

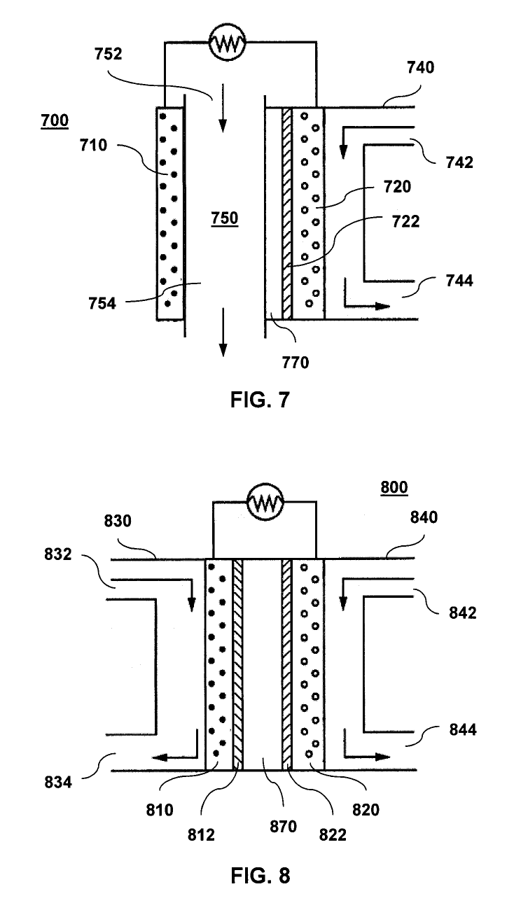

FIG. 7 represents an example of a fuel cell 700 that includes an anode 710, a cathode 720, an oxidant channel 740, a stationary electrolyte 770, a microfluidic channel 750 contiguous with the anode only, and a single flowing electrolyte in the microfluidic channel, where the flowing electrolyte in the microfluidic channel includes a fuel. Microfluidic channel 750 includes an electrolyte inlet 752 and an electrolyte outlet 754. During operation, the single flowing electrolyte passes through the channel 750, preferably in a laminar flow. The anode 710 is in convective contact with the fuel. The cathode 720 includes a GDE and a cathode catalyst, and is in contact with oxidant channel 740, which includes an oxidant inlet 742 and an optional oxidant outlet 744. The cathode 720 may include optional hydraulic barrier 722 contiguous with the stationary electrolyte 770. The optional hydraulic barrier may include the cathode catalyst, or it may be positioned between the cathode catalyst and the stationary electrolyte 770.

FIG. 8 represents an example of a fuel cell 800 that includes an anode 810, a cathode 820, a fuel channel 830, an oxidant channel 840, a stationary electrolyte 870 contiguous with both the anode and the cathode, and a single flowing electrolyte. The anode 810 may include optional hydraulic barrier 812, and the cathode 820 may include optional hydraulic barrier 822. Fuel channel 830 includes a fuel inlet 832 and an optional fuel outlet 834. Oxidant channel 840 includes an oxidant inlet 842 and an optional oxidant outlet 844. One of the fuel channel 830 or the oxidant channel 840 is the microfluidic channel. During operation, the single flowing electrolyte passes through the microfluidic channel, preferably in a laminar flow.

In one example, fuel channel 830 is the microfluidic channel, which is contiguous with the anode 810 only. In this example, the single flowing electrolyte includes a fuel. The anode 810 may be in convective contact with the fuel. The cathode 820 includes a GDE and a cathode catalyst.

In another example, oxidant channel 840 is the microfluidic channel, which is contiguous with the cathode only. In this example, the single flowing electrolyte includes an oxidant. The cathode 820 may be in convective contact with the oxidant. The anode 810 includes a GDE and an anode catalyst.

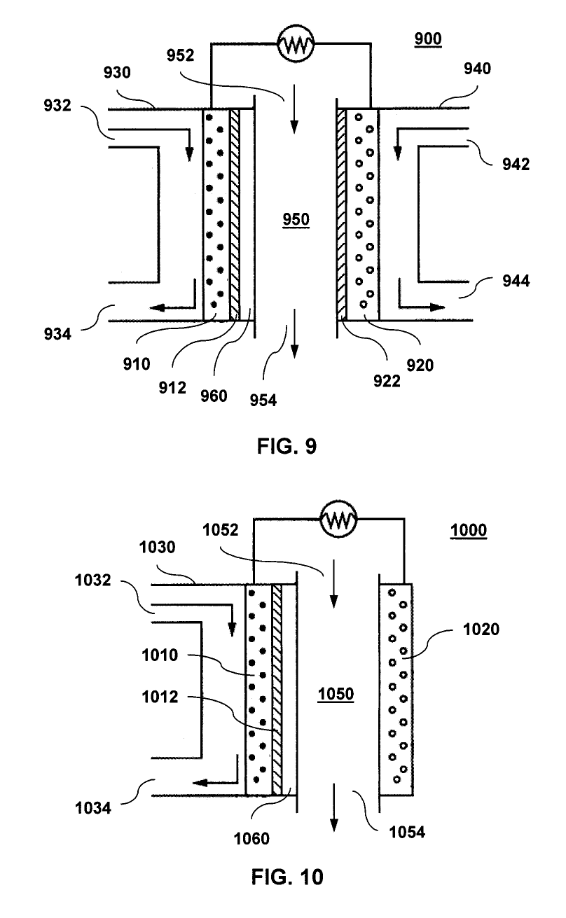

FIG. 9 represents an example of a fuel cell 900 that includes an anode 910 including a GDE, a cathode 920, a fuel channel 930, a stationary electrolyte 960 between the anode and the cathode, a microfluidic channel contiguous with the cathode only, and a single flowing electrolyte including an oxidant. The anode 910 may include optional hydraulic barrier layer 912, and the cathode 920 may include optional hydraulic barrier layer 922. The fuel channel 930 includes a fuel inlet 932 and an optional fuel outlet 934. Cell 900 can be configured in a variety of ways, and may include optional oxidant channel 940, and/or optional central channel 950. Optional oxidant channel 940 includes an oxidant inlet 942 and an optional oxidant outlet 944. Optional central channel 950 includes an electrolyte inlet 952 and an electrolyte outlet 954. The microfluidic channel contiguous with the anode only is one of channels 940 or 950. During operation, the single flowing electrolyte passes through the microfluidic channel, preferably in a laminar flow.

In one example, cell 900 includes the central channel 950, and the stationary electrolyte 960 is between the central channel and the anode 910. In this example, the central channel is the microfluidic channel. In another example, cell 900 includes the oxidant channel 940, and the stationary electrolyte 960 is contiguous with the anode 910 and the cathode 920. In this example, the oxidant channel is the microfluidic channel.

FIG. 10 represents an example of a fuel cell 1000 that includes an anode 1010, a cathode 1020, a fuel channel 1030, a stationary electrolyte 1060, a microfluidic channel 1050 contiguous with the cathode only, and a single flowing electrolyte in the microfluidic channel, where the flowing electrolyte in the microfluidic channel includes an oxidant. Microfluidic channel 1050 includes an electrolyte inlet 1052 and an electrolyte outlet 1054. During operation, the single flowing electrolyte passes through the channel 1050, preferably in a laminar flow. The cathode 1020 is in convective contact with the oxidant. The anode 1010 includes a GDE and an anode catalyst, and is in contact with fuel channel 1030, which includes a fuel inlet 1032 and an optional fuel outlet 1034. The anode 1010 may include optional hydraulic barrier 1012 contiguous with the stationary electrolyte 1060. The hydraulic barrier may include the anode catalyst, or it may be positioned between the anode catalyst and the stationary electrolyte 1060.

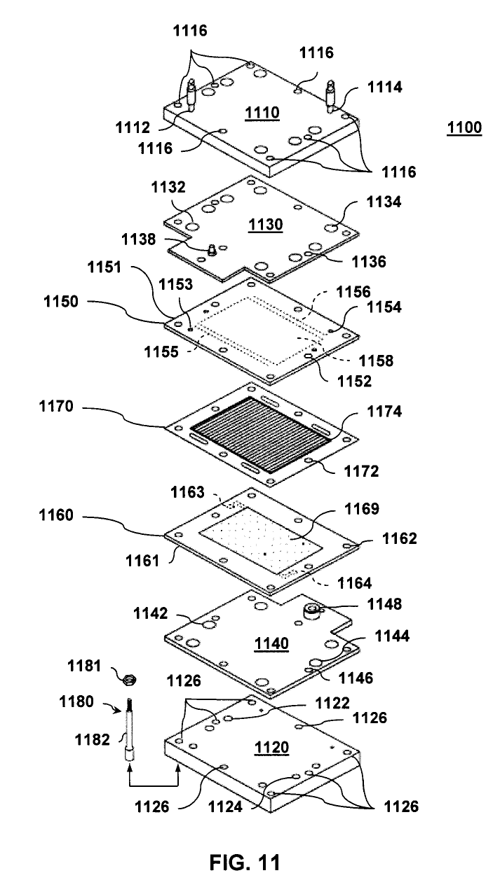

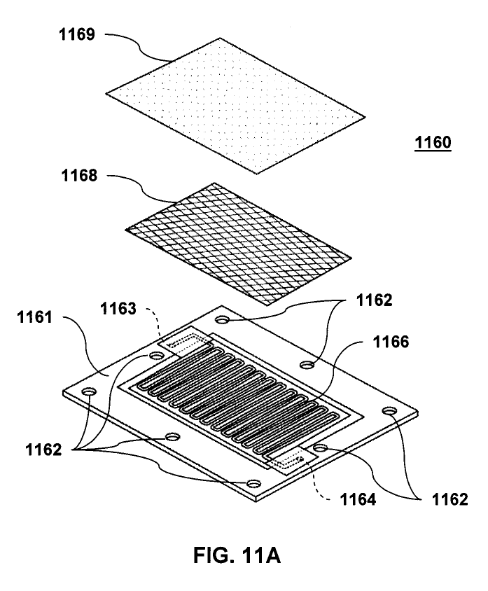

FIGS. 11 and 11A together are an exploded perspective representation of an example of a microfluidic fuel cell 1100 that includes a single flowing electrolyte in a microfluidic channel. Fuel cell 1100 includes back plates 1110 and 1120, current collectors 1130 and 1140, anode plate 1150, cathode plate 1160, microfluidic channel layer 1170, and through-bolts 1180. Back plate 1110 includes an electrolyte inlet 1112, an electrolyte outlet 1114, and eight bolt holes 1116 for through-bolts 1180. Back plate 1120 includes a gas inlet 1122, a gas outlet 1124, and eight bolt holes 1126 for through-bolts 1180. The back plates 1110 and 1120 may be any rigid material, and preferably are electrically insulating. Examples of back plate materials include plastics such as polycarbonates, polyesters, and polyetherimides. The through-bolts 1180 include nuts 1181, and may include optional insulating sleeves 1182.

Current collector 1130 includes electrolyte holes 1132 and 1134, bolt holes 1136 (only one labeled in FIG. 11), and electrical connector 1138. Current collector 1140 includes gas holes 1142 and 1144, bolt holes 1146 (only one labeled in FIG. 11), and electrical connector 1148. The current collectors 1130 and 1140 may include any conducting material, for example metal, graphite, or conducting polymer. The current collectors preferably are rigid, and may include an electrically insulating substrate and an electrically conductive layer on the substrate. Examples of current collector materials include copper plates, gold plates, and printed circuit boards coated with copper and/or gold.

The anode plate 1150 includes a conducting plate 1151 having bolt holes 1152 (only one labeled in FIG. 11), electrolyte inlet 1153, electrolyte outlet 1154, inlet manifold 1155, outlet manifold 1156, and anode 1158. The conducting plate 1151 may include any conducting material, for example metal, graphite, or conducting polymer. Preferably the conducting plate 1151 is rigid. Examples of conducting plate materials include graphite, stainless steel and titanium. Electrolyte inlet 1153 is in fluid communication with inlet manifold 1155, and electrolyte outlet 1154 is in fluid communication with outlet manifold 1156. Anode 1158 includes a mixture of anode catalyst and binder. The anode may be formed, for example, by depositing a catalyst ink containing the anode catalyst and the binder directly to the conducting plate 1151. Preferably the length of the anode is at least equal to the length of the manifolds 1155 and 1156.

FIG. 11A is an exploded perspective representation of the cathode plate 1160. The cathode plate 1160 includes a conducting plate 1161 having bolt holes 1162 (only one labeled in FIG. 11), gas inlet 1163, gas outlet 1164, gas flow channel 1166, cathode 1168 and optional screen 1169. The conducting plate 1161 may include any conducting material, for example metal, graphite, or conducting polymer. Preferably the conducting plate 1161 is rigid. Examples of conducting plate materials include graphite, stainless steel and titanium. The gas inlet 1163 and gas outlet 1164 are in fluid communication through gas flow channel 1166. The cathode 1168 preferably includes a GDE, a cathode catalyst on the GDE, and a hydraulic barrier on the catalyst. Optional screen 1169 overlays the cathode 1168 and the gas flow channel 1166. It is preferable to include screen 1169 if the hydraulic barrier may flow or creep when the cell is sealed.

The microfluidic channel layer 1170 is a non-compressible film having bolt holes 1172 (only one labeled in FIG. 11) and a channel pattern 1174 that includes multiple spaces parallel with the width of the layer. The channel pattern 1174 overlays the manifolds 1155 and 1156 and the anode 1158, and provides part of the microfluidic channel structure. The thickness of the film and the width of the spaces in the pattern 1174 define the dimensions of the microfluidic channels for the flowing electrolyte. The top and bottom of the microfluidic channels are provided by the anode on one side, and by the cathode plate on the other side. Preferably the microfluidic channel layer is electrically and ionically insulating. The term “ionically insulating” means that a material does not conduct ions. Examples of non-compressible film materials include polycarbonates, polyesters, polyphenylene oxide (PPO), polyphenylene sulfide (PPS), poly(etheretherketone) (PEEK), polybenzimidazole (PBI), polyimides including polyetherimide, high-density polyethylene, and poly(tetrafluoroethylene).

The cell 1100 may be assembled by combining the back plates 1110 and 1120, the current collectors 1130 and 1140, the anode plate 1150, the cathode plate 1160 and the microfluidic channel layer 1170, such that the microfluidic channel layer is sandwiched between the anode plate and the cathode plate. Optional adhesive or sealing layers (not shown) may be present between the anode plate 1150 and the microfluidic channel layer 1170 and/or between the cathode plate 1160 and the microfluidic channel layer 1170. Seals such as o-rings or gaskets may be present, such as at one or more of the holes for the electrolyte and gas inlets and outlets. A through-bolt 1180 is placed through each aligned bolt hole, and each bolt is secured at the end with a nut 1181.

The cell 1100 may be operated by connecting the hole 1112 to an electrolyte supply, connecting the hole 1114 to an electrolyte outlet, connecting the hole 1122 to a gas supply, connecting the hole 1124 to a gas outlet, and connecting electrical collectors 1138 and 1148 to an electrical circuit. When an electrolyte containing a fuel is circulated through the electrolyte inlet and outlet, and a gas containing an oxidant is circulated through the gas inlet and outlet, an electric potential is generated, and current flows through the electrical circuit in proportion to the external load.

Fuel cells that include a microfluidic channel and a single flowing electrolyte in the channel may produce at least 0.1 milliamps per square centimeter (mA/cm²). Preferably these fuel cells produce at least 1 mA/cm², more preferably at least 2 mA/cm², more preferably at least 10 mA/cm², more preferably at least 50 mA/cm², more preferably at least 100 mA/cm², more preferably at least 400 mA/cm², and more preferably at least 1000 mA/cm², including 100-1000 mA/cm², 200-800 mA/cm², and 400-600 mA/cm². These fuel cells may operate at voltages of from 1.0 to 0.1 volts (V) for single cells. Preferably these fuel cells operate at voltages of from 0.7 to 0.2 V, and more preferably from 0.5 to 0.25 V for single cells.

Fuel cells including a single flowing electrolyte in a microfluidic channel preferably produce a current density of 200 mA/cm² without cathode flooding, as measured by the polarization flooding test. The polarization flooding test is performed as follows. A fuel cell is connected to a fuel source and a gaseous oxidant source, and electrically connected to a load. The current density is increased, and the potential is measured under two different oxidant flow regimes. In the stoichiometric flow regime, the oxidant gas flow rate is varied based on the electrical current output of the fuel cell so as to maintain the oxygen concentration at 1-3 times the stoichiometric level for the fuel cell reaction. In the elevated flow regime, the oxidant gas flow rate is set so as to maintain the oxygen concentration at over 5 times the stoichiometric level. No back pressure is applied to the oxidant stream in either regime, and the temperature is maintained at 25° C. The current density at which the measured potential for the stoichiometric flow regime is 10% less than the measured potential for the elevated flow regime for a given oxidant is taken as the onset of cathode flooding. Fuel cells including a single flowing electrolyte in a microfluidic channel preferably produce a current density of 300 mA/cm² without cathode flooding, more preferably of 400 mA/cm² without cathode flooding, and more preferably of 500 mA/cm² without cathode flooding, where cathode flooding is measured by the polarization flooding test.

An individual fuel cell including a single flowing electrolyte in a microfluidic channel may be incorporated into a fuel cell stack, which is a combination of electrically connected fuel cells. The fuel cells in a stack may be connected in series or in parallel. The individual fuel cells may have individual electrolyte, fuel and/or oxidant inputs. Two or more of the cells in a stack may use a common source of electrolyte, fuel and/or oxidant. A fuel cell stack may include only one type of fuel cell, or it may include at least two types of fuel cells. Preferably a fuel cell stack includes multiple fuel cells, each having a single flowing electrolyte in a microfluidic channel, where the cells are connected in series, and where the electrolyte, fuel and oxidant are supplied from a common source.

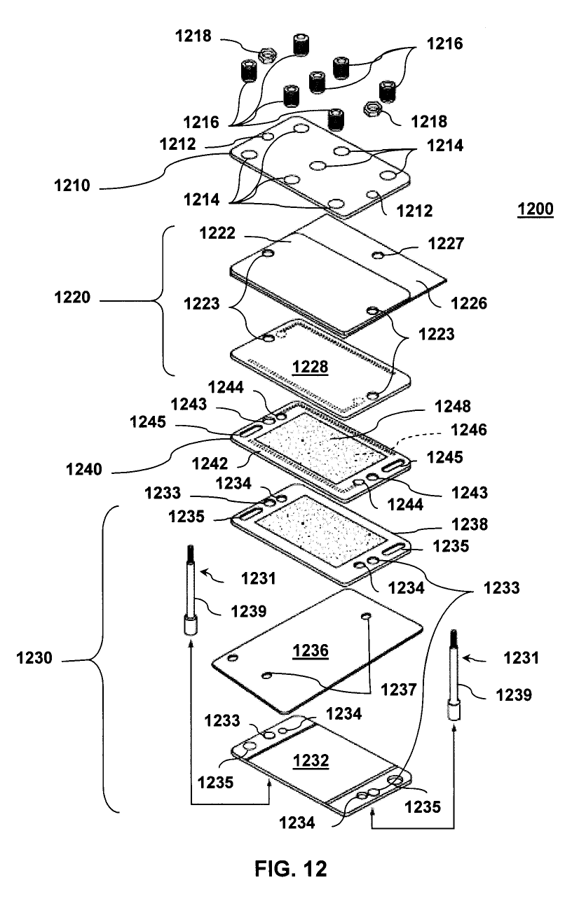

FIG. 12 is an exploded perspective representation of an example of a microfluidic fuel cell stack 1200 including multiple fuel cells that each includes a single flowing electrolyte in a microfluidic channel. Fuel cell stack 1200 includes a compression plate 1210, an anode endplate 1220, a cathode endplate 1230, and multiple electrode assemblies 1240. The compression plate 1210 includes holes 1212 on either end and includes threaded holes 1214 along the length of the plate and in the center of the plate. Holes 1212 are for through-bolts 1231, which pass through the height of the stack 1200, and are secured with nuts 1218. Set screws 1216 may be threaded into the threaded holes 1214 and tightened against the anode endplate 1220 to contribute to the sealing of the stack. The compression plate may be any rigid material, for example metal, glass, ceramic or plastic. Examples of compression plate materials include plastics such as polycarbonates, polyesters, and polyetherimides; and metals such as stainless steel and titanium.

The anode endplate 1220 includes a back plate 1222, holes 1223 for the through-bolts 1231, a current collector 1226, and an anode assembly 1228. The back plate 1222 may be any rigid material, for example metal, glass, ceramic or plastic. The current collector 1226 may include any conducting material, for example metal, graphite, or conducting polymer. The current collector can be connected to an electrical circuit, such as by attaching an electrical binding post to an optional hole 1227 at the side edge of the current collector. The back plate and current collector optionally may be separated by an insulating layer (not shown). An insulating layer may be unnecessary if the back plate is not electrically conductive. The anode assembly 1228 preferably includes an anode having an anode catalyst, and a microfluidic channel structure.

The cathode endplate 1230 includes through-bolts 1231, a back plate 1232, holes 1233 for the through-bolts 1231, holes 1234 for electrolyte channels, holes 1235 for gas channels, a current collector 1236, and a cathode assembly 1238. The back plate 1232 may be any rigid material, for example metal, glass, ceramic or plastic. The current collector 1236 may include any conducting material, for example metal, graphite, or conducting polymer. The current collector can be connected to an electrical circuit, such as by attaching an electrical binding post to an optional hole 1237 at the side edge of the current collector. The back plate and current collector optionally may be separated by an insulating layer (not shown). An insulating layer may be unnecessary if the back plate is not electrically conductive. The through-bolts 1231 may include optional insulating sleeves 1239. The cathode assembly 1238 preferably includes a GDE, a cathode catalyst, and a hydraulic barrier.

The electrode assembly 1240 includes a bipolar plate 1242, holes 1243 for the through-bolts 1231, holes 1244 for electrolyte channels, holes 1245 for gas channels, an anode face 1246, and a cathode face 1248. The bipolar plate 1242 provides for electrical conduction between the anode face 1246 and the cathode face 1248. The combination of a single electrode assembly 1240 with an anode endplate 1220 and a cathode endplate 1230 provides for two complete fuel cells connected in series, with one cell between the anode endplate and the cathode face of the electrode assembly, and the other cell between the cathode endplate and the anode face of the electrode assembly. Multiple electrode assemblies may be arranged in series, such that the cathode face 1248 of one assembly is in contact with the anode face 1246 of the other assembly. The number of fuel cells in stack 1200 is one plus the number of electrode assemblies 1240 in the stack.

The stack 1200 may be assembled by combining the compression plate 1210, the anode plate 1220, multiple electrode assemblies 1240, and the cathode plate 1230, such that the anode assembly 1228 is in contact with the cathode face 1248 of an electrode assembly, the cathode assembly 1238 is in contact with the anode face 1246 of another electrode assembly, and the electrode assemblies are oriented such that the cathode and anode faces are in contact in pairs. A through-bolt 1231 is placed through each bolt hole provided when the components are aligned, and each bolt is secured at the end with a nut 1218. The set screws 1216 are tightened against the anode plate as necessary to seal the stack.

The stack 1200 may be operated by connecting one hole 1234 to an electrolyte supply, connecting the other hole 1234 to an electrolyte outlet, connecting one hole 1235 to a gas supply, connecting the other hole 1235 to a gas outlet, and connecting current collectors 1226 and 1236 to an electrical circuit. When an electrolyte containing a fuel is circulated through the electrolyte inlet and outlet, and a gas containing an oxidant is circulated through the gas inlet and outlet, an electric potential is generated, and current flows through the electrical circuit in proportion to the external load.

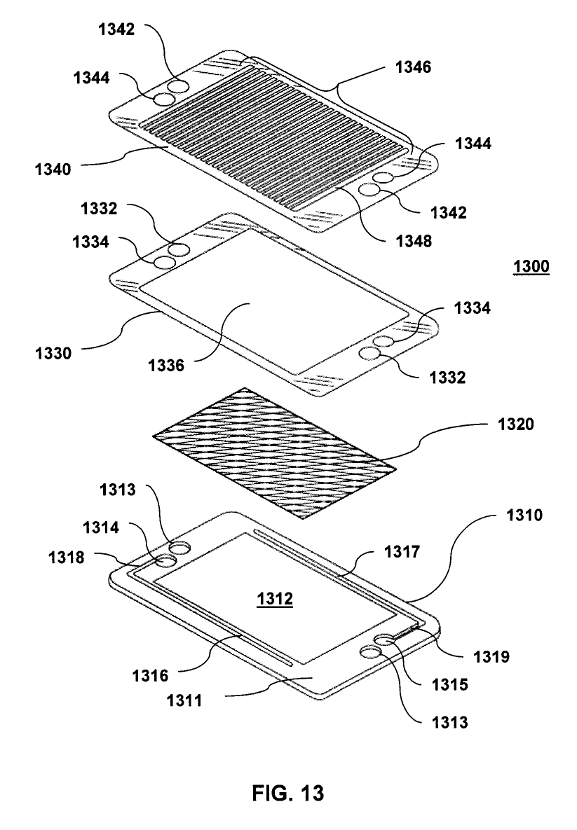

FIG. 13 is an exploded perspective representation of an example of an anode assembly 1300 that may be used as an anode assembly 1228 in fuel cell stack 1200. Anode assembly 1300 includes an anode plate 1310, an anode 1320, optional gasket 1330, and a microfluidic channel layer 1340. The anode plate 1310 includes a perimeter 1311, a conductive region 1312 inside the perimeter, holes 1313, indentations 1314 and 1315, manifolds 1316 and 1317, conduit channels 1318 and 1319. Preferably the anode plate 1310 is rigid. The perimeter 1311 and the conductive region 1312 may be a single piece of conducting material, such as metal, graphite or conducting polymer. Examples of conducting materials include graphite, stainless steel and titanium. The perimeter 1311 and the conductive region 1312 may be different materials. For example, the perimeter may be an electrically and ionically insulating material. Examples of perimeter materials include polycarbonates, polyesters, polyphenylene oxide (PPO), polyphenylene sulfide (PPS), poly(etheretherketone) (PEEK), polybenzimidazole (PBI), polyimides including polyetherimide, high-density polyethylene, and poly(tetrafluoroethylene). The top surfaces of the perimeter 1311 and the conductive region 1312 may be co-planar, or they may be in different planes. For example, at least a portion of the conductive region may be inset into the plate, such that it forms a trough in the center of the plate.

The holes 1313 align with through-bolt holes that pass through the height of a stack in which the anode assembly is present. The indentations 1314 and 1315 are an inlet and an outlet, respectively, for a single flowing electrolyte. Inlet indentation 1314 is in fluid communication with inlet manifold 1316 through conduit channel 1318. Outlet indentation 1315 is in fluid communication with outlet manifold 1317 through conduit channel 1319. Preferably the inlet, outlet, manifolds and conduit channels are electrically and tonically isolated from the conductive region 1312. In one example, the inlet, outlet, manifolds and conduit channels are present in a perimeter 1311 that is electrically and ionically insulating. In another example, the inlet, outlet, manifolds and conduit channels are coated with a material that is an electrical and ionic insulator, such as an ULTEM® coating. Preferably each manifold terminates at a point in line with the end of the conductive region 1312.

The anode 1320 includes an anode catalyst, and optionally includes a carbon layer. In one example, a catalyst ink containing Pt/Ru catalyst and Nafion® binder is applied directly to the conducting region 1312. In another example, a catalyst ink is applied to a graphite sheet and subjected to hot-pressing to stiffen the electrode and to normalize the electrode height. From this material, an individual anode can be cut to an appropriate size, such as a size matching the conducting region 1312, or a size matching the inner dimensions of a trough of the conducting region 1312. The anode may be adhered to the conducting region during assembly of the stack by a small amount of carbon paint.

The optional gasket 1330 is a material having a minimum compressed thickness. Optional gasket 1330 includes a hole 1332 at each end for a through-bolt, a hole 1334 at each end for an electrolyte channel, and a central opening 1336. In one example, the gasket includes a non-compressible film that is hot-bonded to the perimeter 1311 of the anode plate. This type of gasket may be useful when the anode 1320 is formed from the direct application of a catalyst ink. In another example, the gasket includes a non-compressible film having an adhesive on each side. One side of the film is adhered to a compressible film, and the other side of the film is adhered to the perimeter 1311 of the anode plate. The gasket of this example may be useful when the anode 1320 includes an anode catalyst on a carbon layer, since the thickness of the compressed gasket can match the thickness of the anode that extends above the plane of the anode plate 1310.

The microfluidic channel layer 1340 is a non-compressible film having a hole 1342 at each end for a through-bolt, a hole 1344 at each end for an electrolyte channel, and a channel pattern 1346 that includes multiple spaces 1348. The channel pattern 1346 overlays the manifolds 1316 and 1317 and the anode 1320, and provides part of the microfluidic channel structure. The thickness of the film and the width of the spaces 1348 define the dimensions of the microfluidic channels for the flowing electrolyte. The top and bottom of the microfluidic channels are provided on one side by the anode, and on the other side by a cathode assembly or the cathode face of an electrode assembly.

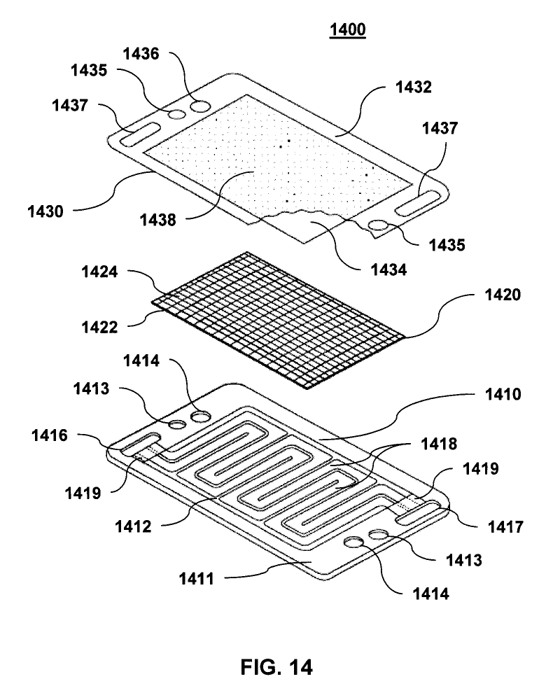

FIG. 14 is an exploded perspective representation of an example of a cathode assembly 1400 that may be used as a cathode assembly 1238 in fuel cell stack 1200. Cathode assembly 1400 includes a cathode plate 1410, a cathode 1420 that includes a GDE 1422 and a cathode catalyst 1424, and a barrier layer 1430 that includes a screen 1432 and a hydraulic barrier 1434. The cathode plate 1410 includes a perimeter 1411, a conductive region 1412 inside the perimeter, holes 1413, 1414, 1416 and 1417, and gas flow channels 1418. Preferably the cathode plate is rigid. The perimeter 1411 and the conductive region 1412 may be a single piece of conducting material, such as metal, graphite or conducting polymer. The perimeter 1411 and the conductive region 1412 may be different materials. For example, the perimeter may be an electrically and ionically insulating material.

The holes 1413 align with through-bolt holes that pass through the height of the stack in which the cathode assembly is present. The holes 1414 align with electrolyte channels that pass through the height of the stack, and the holes 1416 and 1417 align with gas channels that pass through the height of the stack. Preferably the holes 1414 are electrically and ionically isolated from the conductive region 1412. In one example, the holes 1414 are present in a perimeter 1411 that is electrically and ionically insulating. In another example, the holes and/or the entire perimeter 1411 are coated with a material that is an electrical and ionic insulator, such as an ULTEM® coating.

The gas flow channels 1418 may have a variety of configurations. FIG. 14 illustrates serpentine flow channels, in which each of the two flow channels traverses across the conductive region 1412 from inlet hole 1416 to outlet hole 1417. In another configuration, one gas flow channel is connected only to inlet hole 1416, while the other gas flow channel is connected only to outlet hole 1417. In this interdigitated configuration, the gas from the inlet 1416 passes from an inlet channel, through a portion of the GDE 1422, to the outlet channel, and then to outlet 1417. At either end of the flow channels, a bridge 1419 is present over the portion of the gas flow channels 1418 that extends from a hole 1416 or 1417 to the conductive region 1412. The bridge 1419 may be integral with the cathode plate 1410, or it may be a separate piece that fits over the portion of the gas flow channels. The bridge 1419 may be the same material as the cathode plate, or it may be a different material.

The cathode 1420 may include a GDE 1422 that is coated on one side with a catalyst ink, such as an ink containing a cathode catalyst and a binder. The coated GDE may be dried to form a layer of catalyst 1424 on the GDE. An individual cathode 1420 may then be cut from this coated GDE, such as to a size matching that of the conductive region 1412.

The barrier layer 1430 includes a screen layer 1432 that includes a non-compressible film. The screen layer 1432 has a hole 1435 at each end for a through-bolt, a hole 1436 at each end for an electrolyte channel (only one shown), a hole 1437 at each end for a gas channel, and a mesh 1438. The mesh allows liquid to pass through the central area of the screen layer. In one example, the screen layer is made of stainless steel. The hydraulic barrier 1434 is a film of material that can maintain a concentration gradient between two fluids of differing concentration on either side of the film, preventing mixing of the bulk of the two fluids. Examples of hydraulic barrier materials include Nafion® and hydrogels. In one example, a hydraulic barrier precursor material is deposited on the mesh 1438 of the screen layer and then dried to form hydraulic barrier 1434.

The cathode assembly 1400 may be assembled by bonding the cathode 1420 to the barrier layer 1430, and then placing the barrier layer 1430 on the conductive region 1412 of the cathode plate 1410. The cathode 1420, the hydraulic barrier 1434, and the mesh 1438 overlay the conductive region 1412. The barrier layer may be attached to the cathode plate by an adhesive, such as a double-sided Kapton® tape having openings for the conductive region, through-bolts, and electrolyte and gas channels. Pressure and/or heat may be applied to seal the cathode assembly.

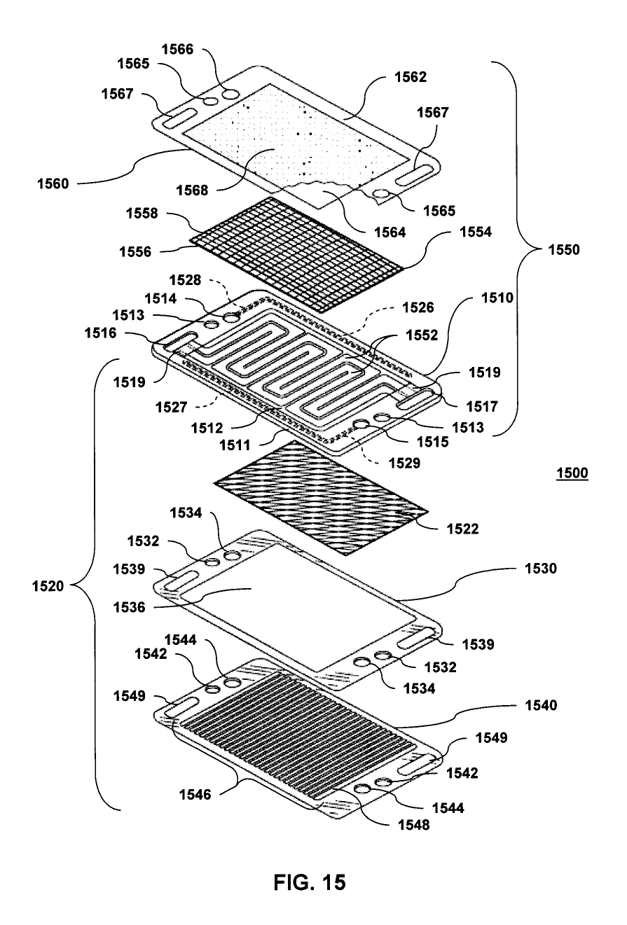

FIG. 15 is an exploded perspective representation of an example of an electrode assembly 1500 that may be used as an electrode assembly 1240 in fuel cell stack 1200. Electrode assembly 1500 includes a bipolar plate 1510, an anode face 1520 and a cathode face 1550. The bipolar plate 1510 includes a perimeter 1511, a conductive region 1512, and holes 1513, 1514, 1515, 1516 and 1517. Preferably the bipolar plate 1510 is rigid. The perimeter 1511 and the conductive region 1512 may be a single piece of conducting material, such as metal, graphite or conducting polymer. The perimeter 1511 and the conductive region 1512 may be different materials. For example, the perimeter may be an electrically and ionically insulating material. The conducting region 1512 provides for electrical conduction between the anode face 1520 and the cathode face 1550 of the electrode assembly.

The holes 1513 align with through-bolt holes that pass through the height of a stack in which the electrode assembly is present. The holes 1514 and 1515 align with electrolyte channels that pass through the height of the stack. The holes 1516 and 1517 align with gas channels that pass through the height of the stack.

The anode face 1520 includes an anode 1522, optional gasket 1530, a microfluidic channel layer 1540, manifolds 1526 and 1527, and conduit channels 1528 and 1529. On the anode side of the bipolar plate 1510, the surfaces of the perimeter 1511 and the conductive region 1512 may be co-planar, or they may be in different planes. For example, at least a portion of the conductive region may be inset into the plate, such that it forms a trough in the center of the anode side of the plate. Conduit channel 1528 provides fluid communication between inlet manifold 1526 and hole 1514. Conduit channel 1529 provides fluid communication between outlet manifold 1527 and hole 1515. Preferably the holes 1514 and 1515, the manifolds 1526 and 1527, and the conduit channels 1528 and 1529 are electrically and ionically isolated from the conductive region 1512. In one example, the holes, manifolds and conduit channels are present in a perimeter 1511 that is electrically and ionically insulating. In another example, the holes are coated with a material that is an electrical and ionic insulator, such as an ULTEM® coating.

The anode 1522 includes an anode catalyst, and optionally includes a carbon layer. The anode may be as described above for the anode 1320 of the anode assembly 1300. An individual anode can be cut to an appropriate size, such as a size matching the conducting region 1512, or a size matching the inner dimensions of a trough of the conducting region 1512. The anode may be adhered to the conducting region during assembly of the stack by a small amount of carbon paint.

The optional gasket 1530 is a compressible material having a minimum compressed thickness. Optional gasket 1530 includes a hole 1532 at each end for a through-bolt, a hole 1534 at each end for an electrolyte channel, a central opening 1536, and a hole 1539 at each end for a gas channel. In one example, the gasket includes a non-compressible film having an adhesive on each side. One side of the film is adhered to a compressible film, and the other side of the film is adhered to the anode side of the perimeter 1511 of the bipolar plate. The gasket of this example may be useful when the anode 1522 includes an anode catalyst on a carbon layer, since the thickness of the compressed gasket can match the thickness of the anode that extends above the plane of the bipolar plate 1510.

The microfluidic channel layer 1540 is a non-compressible film having a hole 1542 at each end for a through-bolt, a hole 1544 at each end for an electrolyte channel, a channel pattern 1546 that includes multiple spaces 1548, and a hole 1549 at each end for a gas channel. The channel pattern 1546 overlays the manifolds 1526 and 1527 and the anode 1522, and provides part of the microfluidic channel structure. The thickness of the film and the width of the spaces 1548 define the dimensions of the microfluidic channels for the flowing electrolyte. The top and bottom of the microfluidic channels are provided on one side by the anode, and on the other side by the cathode assembly or the cathode face of an electrode assembly.

The cathode face 1550 includes gas flow channels 1552, a cathode 1554 that includes a GDE 1556 and a cathode catalyst 1558, and a barrier layer 1560 that includes a screen 1562 and a hydraulic barrier 1564. The gas flow channels 1552 may have a variety of configurations, such as those described for the gas flow channels 1418 of the cathode assembly 1400. The gas flow channels provide for flow of gas across the conductive region 1512 between the inlet hole 1516 and the outlet hole 1517. At either end of the flow channels, a bridge 1519 is present over the portion of the gas flow channels 1552 that extends from a hole 1516 or 1517 to the conductive region 1512. The bridge 1519 may be integral with the bipolar plate 1510, or it may be a separate piece that fits over the portion of the gas flow channels. The bridge 1519 may be the same material as the bipolar plate, or it may be a different material.

The cathode 1554 may include a GDE 1556 that is coated on one side with a catalyst ink, such as an ink containing a cathode catalyst and a binder. The coated GDE may be dried to form a layer of catalyst 1558 on the GDE. An individual cathode 1554 may then be cut from this coated GDE, such as to a size matching that of the conductive region 1512. The barrier layer 1560 includes a screen layer 1562 that includes a non-compressible film. The screen layer 1562 has a hole 1565 at each end for a through-bolt, a hole 1566 at each end for an electrolyte channel (only one shown), a hole 1567 at each end for a gas channel, and a mesh 1568. The screen layer 1562, the hydraulic barrier 1564, and the assembly of the cathode face with the bipolar plate may be as described for the cathode assembly 1400.

Examples of back plate materials include plastics such as polycarbonates, polyesters, and polyetherimides; and metals such as stainless steel and titanium. Examples of current collector materials include copper plates, gold plates, and printed circuit boards coated with copper and/or gold. Examples of insulating layer materials include polysiloxanes, polyphenylene oxide (PPO), polyphenylene sulfide (PPS), poly(etheretherketone) (PEEK), polybenzimidazole (PBI), polyimides including polyetherimide, high-density polyethylene, and poly(tetrafluoroethylene). Examples of conducting materials for electrode plates and bipolar plates, or for conducting regions within these plates, include graphite, stainless steel and titanium. Examples of perimeter materials include polycarbonates, polyesters, polyphenylene oxide (PPO), polyphenylene sulfide (PPS), poly(etheretherketone) (PEEK), polybenzimidazole (PBI), polyimides including polyetherimide, high-density polyethylene, and poly(tetrafluoroethylene). Examples of non-compressible film materials include polycarbonates, polyesters, polyphenylene oxide (PPO), polyphenylene sulfide (PPS), poly(etheretherketone) (PEEK), polybenzimidazole (PBI), polyimides including polyetherimide, high-density polyethylene, and poly(tetrafluoroethylene). Examples of compressible film materials include ePTFE, polysiloxanes, and expanded polyethylene.

Fuel cells including a single flowing electrolyte in a microfluidic channel, and fuel cell stacks including such fuel cells, may be incorporated into a power supply device. A power supply device includes other components, including components that deliver the fuel and oxidant to the cell or stack. Examples of input components include reservoirs of electrolyte, fuel, and/or oxidant; pumps; blowers; mixing chambers; and valves. Other components that may be present in a power supply device include vents, electrical connectors, a power converter, a power regulator, an auxiliary power supply, a heat exchanger, and temperature control components.

A power supply device may include control components, such as sensors and computer readable program code. Sensors may be used to measure various properties of the cell, stack and/or device, such as temperature, composition of input and/or output streams, reagent supply levels, electrochemical performance of the cell or stack, and electrical performance of the device. Computer readable program code may be stored on a microprocessor, a memory device or on any other computer readable storage medium. The program code may be encoded in a computer readable electronic or optical signal. The code may be object code or any other code describing or controlling the functionality described in this application. The computer readable storage medium may be a magnetic storage disk such as a floppy disk; an optical disk such as a CD-ROM; semiconductor memory; or any other physical object storing program code or associated data. A computer readable medium may include a computer program product including the computer readable program code. Algorithms, devices and systems relating to the code may be implemented together or independently. The sensors may provide input to the code regarding the properties of the cell, stack and/or device.

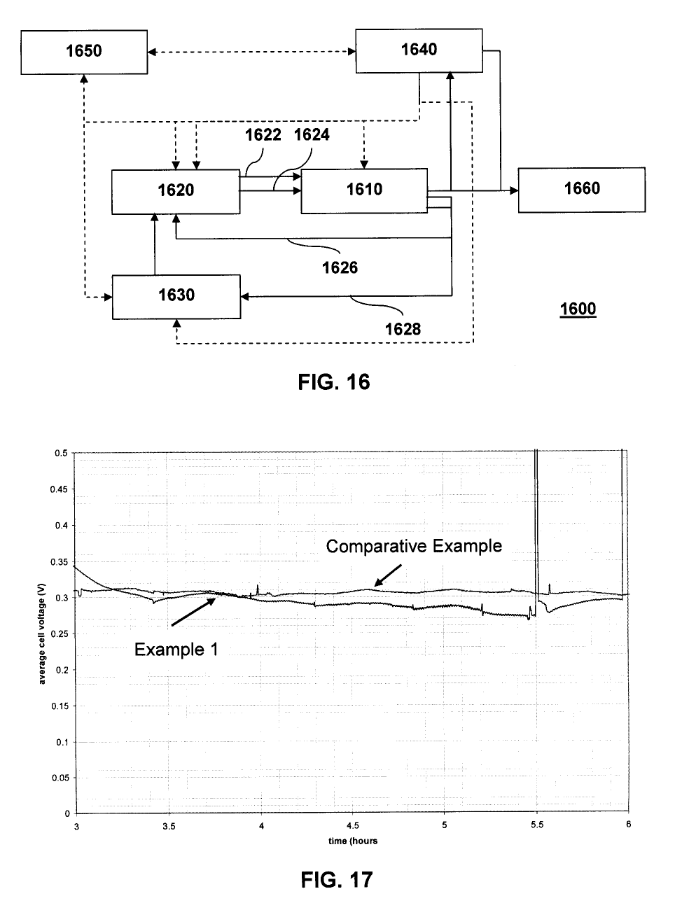

FIG. 16 is a schematic representation of an example of a power supply device 1600 that may be a portable power supply device. Power supply device 1600 includes a fuel cell stack 1610, a reagent system 1620, an optional heat exchanger 1630, an auxiliary power supply 1640, a control system 1650, and an output connection 1660. The fuel cell stack 1610 includes one or more fuel cells having a single flowing electrolyte in a microfluidic channel.

The reagent system 1620 includes an electrolyte reservoir, a fuel reservoir, an optional oxidant reservoir, a mixing chamber, one or more pumps, an optional blower, a fuel supply line 1622 for delivering fuel to the stack 1610, and an oxidant supply line 1624 for delivering oxidant to the stack. The electrolyte may be mixed with either the fuel or the oxidant. If the oxidant is air, the optional blower may be present to facilitate delivery of the oxidant to the stack. If the oxidant is a gas other than air, the reagent system 1620 may include the optional oxidant reservoir, such as a supply of compressed gas. The reagent system 1620 may include return lines for the effluent electrolyte mixture 1626 and/or for the effluent gas mixture 1628. The effluent electrolyte mixture may be returned to the mixing chamber. The effluent gas mixture may be vented outside of the stack; however, water in the effluent gas may be condensed into the mixing chamber by the optional heat exchanger 1630.

The optional heat exchanger 1630 includes a gas inlet, a gas outlet, and a heat exchange fluid. The gas inlet can accept effluent gas from the stack 1610, and the gas may be vented from the gas outlet to the surrounding environment. The gas may flow in gas flow channels through the heat exchange fluid, and/or the gas may flow around channels containing the heat exchange fluid. The heat exchange fluid preferably is at a lower temperature than the effluent gas from the stack. Heat exchange fluids may include, for example, ethylene glycol and/or propylene glycol. The temperature of the heat exchange fluid may be controlled by circulating atmospheric air around a container for the fluid. Temperature control of the heat exchange fluid also may include circulating the fluid, such as circulating through fluid channels, so that the circulating atmospheric air can more effectively absorb heat from the fluid.

The auxiliary power supply 1640 is used to provide power to the other components of the device 1600. The power from the auxiliary power supply may be used throughout the operation of the device, or it may be used until the fuel cell stack 1610 can provide sufficient power to the other components. The auxiliary power supply preferably includes a rechargeable battery. The rechargeable battery may be charged by the fuel cell stack and/or by an external power source.

The control system 1650 provides for control of the other components of the device 1600. Examples of processes that may be controlled by the control system include turning the auxiliary power supply 1640 on and off, turning the components of the reagent system 1620 on and off, adjusting the input of fuel or oxidant into an electrolyte mixture, and controlling the rate of heat exchange from the effluent gas. Examples of processes that may be controlled by the control system also include the distribution of power from the auxiliary power supply 1640 and/or the stack 1610 to the other components of the device, cycling of the fuel cell stack, safety protocols such as emergency shut-down of the device, and transmitting a signal to a user of the device. The control system may be activated by a switch and/or may be activated when an electrical load is connected to the device.

In one example, the power supply device 1600 can provide electrical power to an electrical load connected to the device when the control system 1650 is activated. In this example, the fuel is present in an electrolyte/fuel mixture. In a first phase, electrical power is supplied to the load, to the reagent system 1620, to the heat exchanger 1630, and to the control system 1650 by the auxiliary power supply 1640. At start-up, the electrolyte/fuel mixture within the fuel cell stack 1610 preferably includes a higher concentration of fuel than that used during ongoing operation of the stack. The reagent system 1620 may start the delivery of the electrolyte/fuel mixture and the oxidant simultaneously, or it may start the delivery of one reagent first, followed by the other reagent after a delay time. The stack 1610 begins to produce electrical power, and also may warm up to a predetermined operating temperature range.

In a second phase, once the power from the stack 1610 has reached a threshold level, the control system 1650 turns off the auxiliary power supply 1640. The load, the reagent system 1620, the heat exchanger 1630 and the control system 1650 are then powered by the stack 1610. The power from the stack 1610 is also used to recharge the auxiliary power supply 1640. The control system can adjust various parameters of the device, based on predetermined operating programs and/or on measurements from sensors in the device. For example, the operation and/or speed of a fan that circulates air past a heat exchange fluid container can be controlled based on the internal cell resistance, such that a lower internal resistance results in a higher rate of heat exchange. In another example, the concentration of fuel in the electrolyte/fuel mixture can be raised or lowered during operation. In another example, the auxiliary power supply 1640 can be turned on for a variety of reasons, such as an increase in power draw by the load, an “off” cycle of the stack 1610, depletion of the fuel or oxidant, or to make up for declining stack performance.

In a third phase, the device 1600 is shut down. Shut down of the device may be initiated manually or may be initiated automatically, such as by the disconnection of the load from the device. The concentration of fuel in the electrolyte/fuel mixture is raised to a level higher than that used during the second phase, and the mixture is briefly circulated through the stack 1610. The control system 1650 may perform other functions, such as closing of valves and vents, resetting of switches, and switching the output connection 1660 such that it is connected to the auxiliary power supply 1640.

Fuel cells including a single flowing electrolyte in a microfluidic channel, and fuel cell stacks and/or power supply devices including such fuel cells, may be useful in portable and mobile fuel cell systems and in electronic devices. Examples of electronic devices that may be powered at least in part by such cells, stacks or power supply devices include cellular phones, laptop computers, DVD players, televisions, personal data assistants (PDAs), calculators, pagers, hand-held video games, remote controls, cassette players, CD players, radios, audio players, audio recorders, video recorders, cameras, navigation systems, and wristwatches. This technology also may be useful in automotive and aviation systems, including systems used in aerospace vehicles.

The following examples are provided to illustrate one or more preferred embodiments of the invention. Numerous variations may be made to the following examples that lie within the scope of the invention.

### EXAMPLES

### Example 1

### Microfluidic Fuel Cell Stack Having a Single Flowing Electrolyte

A microfluidic fuel cell stack was assembled by combining two back plates, two current collectors, an anode endplate, a cathode endplate, 15 electrode assemblies, and through-bolts. The stack had a length of 11 cm, a width of 9.2 cm, and a height of 7.3 cm.

The back plates were ULTEM® polyetherimide plates each having a thickness of 1.2 cm. Each plate had eight holes for through-bolts at the perimeter of the plate, with one hole at each corner, and one hole at the middle of each side of the plate. The back plate on the anode side had one threaded hole for the electrolyte inlet port, and another threaded hole for the gas inlet port. The back plate on the cathode side had one threaded hole for the electrolyte outlet port, and another threaded hole for the gas outlet port. These threaded holes were each fitted with an o-ring.

The current collector plates were FR-4 printed circuit board plates having a copper coating on one side, and having a gold coating on the copper. In the stack, the electrically insulating face of each plate was in contact with the back plate. Each plate had eight through-bolt holes and two port holes, which aligned with these holes on the respective back plates. Each plate also had a portion of 3.5 cm in length and 1.0 cm in width that extended from the end edge of the stack when assembled. These extensions were each fitted with an electrical binding post connector.

The anode endplate included a graphite plate (SGL Carbon) having a thickness of 2.5 mm, and having through-bolt holes and port holes that aligned with those of the back plate and the current collector plate. The side of the graphite plate in contact with the current collector was flat. The other side of the graphite plate included two manifold channels, each extending along a portion of the length edge of the plate, and two conduit channels perpendicular to the manifolds. Each conduit channel was 3.5 mm in diameter, and connected a manifold channel to an electrolyte port. Each manifold channel was 8.0 cm long and 2 mm wide. The conduit channels and manifold channels each had a depth of 1 mm. Where the conduit connects to the manifold, a 10 mm×5 mm rectangular area was inset into the plate by 0.25 mm. A 0.25 mm thick stainless steel bridge piece was electrically and ionically insulated and placed into each inset.

A Kapton® polyimide film with a b-staged acrylic adhesive was hot-bonded to this side of the graphite plate. The hot bonding was conducted at 5,000 pounds (lbs) and 360° F. in a Carver press for 1 hour. The film included holes aligning with the through-bolt holes and the port holes, spaces aligning with the manifold channels and with the portions of the conduit channels that were not covered by the bridge pieces, and a rectangular space in the center having a length of 8.2 cm and a width of 6 cm.

The anode endplate included an anode catalyst in the center of the graphite plate, in the rectangular space of the Kapton® film. A mixture of 5-7 mg/cm² 50/50 Pt/Ru and Nafion® (catalyst to binder ratio of 9:1) was painted onto the plate. The plate was then hot pressed at 300° F. and 5,000 pounds in a Carver press for 5 mins to match the height of the Kapton® film.

The anode endplate included a microfluidic channel layer, which was a film of Kapton FN929 that had been patterned by laser machining. The film had a length of 11 cm, a width of 9.2 cm, and a thickness of 75 micrometers. The film included holes aligning with the through-bolt holes and the port holes. The center of the film had 27 parallel rectangular spaces, each having a length of 6.4 cm, a width of 2 mm, and spaced from each other by 0.5 mm. When the microfluidic channel layer was placed on the anode endplate, the pattern of the microfluidic channel layer overlaid the anode, the manifold channels, and the exposed portions of the conduit channels. The electrolyte inlet and outlet ports were then in fluid connection by way of the microfluidic channels between the two manifolds.

The cathode endplate included a graphite plate (SGL Carbon) having a thickness of 2.5 mm, and having through-bolt holes and port holes that aligned with those of the back plate and the current collector plate. The side of the graphite plate in contact with the current collector was flat. The other side of the graphite plate included three serpentine flow channels in the center of the plate. The overall flow channel area had a length of 8 cm and a width of 5.6 cm. The individual channels each had a width of 2 mm, a depth of 1 mm, and made 9 passes across the width of the channel area. The flow channels were connected to the gas ports with a conduit channel that was 8 mm long, 2 mm wide, and parallel to the width of the plate. Where the serpentine channels connected with the conduits, a 1 cm×1.1 cm rectangular area was inset into the plate by 0.25 mm. A 0.25 mm thick stainless steel bridge piece was placed into each inset, spanning across the ends of the three serpentine channels.

A gasket including a double-sided Kapton® tape having an expanded poly(tetrafluoroethylene) (ePTFE) film on one side was adhered to this side of the graphite plate. The gasket included holes aligning with the through-bolt holes and the port holes. The Kapton® portion had a rectangular space in the center having a length of 8.2 cm and a width of 5.8 cm, and the ePTFE portion had a rectangular space in the center having a length of 8.8 cm and a width of 6.4 cm.

The cathode endplate included a cathode including a gas diffusion electrode (GDE) and a cathode catalyst. The GDE was a 10% teflonized carbon substrate with a microporous layer on one side and a total thickness of 235 micrometers (Sigracet® 24 BC; SGL Carbon). The microporous side was coated with a catalyst ink. The ink contained 50 wt % platinum on carbon black (HiSPEC™ 8000; Alfa Aesar) in a 5 wt % solution of Nafion® in a mixture of water and alcohols (Aldrich Chemicals, Lot # 10106DE), for a 1:1 ratio of platinum to binder. The coated GDE was dried on a hot plate to form a cathode sheet that contained 6 mg/cm² solids, corresponding to a platinum loading of 2 mg/cm². An individual cathode was cut from this sheet, to a size matching the rectangular space of the Kapton® portion of the gasket.

The cathode endplate included a barrier layer including a screen and a hydraulic barrier. The screen was a stainless steel mesh film having a length of 8.8 cm, a width of 6.4 cm, and a thickness of 0.05 mm. The mesh had a porosity of 80% and pore dimensions of 0.584 mm by 0.51 mm. The hydraulic barrier was a Nafion® 112 film having dimensions matching those of the screen. The hydraulic barrier was applied to the screen to form the barrier layer by hot bonding at 8,000 lbs and 300° F. in a Carver press for 5 mins. This composite was then combined with the cathode by placing the hydraulic barrier in contact with the cathode catalyst, and then hot bonding at 3,000 lbs and 300° F. in a Carver press for 5 mins. The cathode/barrier layer combination was then positioned on the cathode plate such that the edges of the barrier layer were in contact with the exposed Kapton® portion of the gasket. The cathode endplate was then pressed at 25° C. and 3,000 pounds in a Carver press.

The 15 electrode assemblies were identical and included a bipolar plate having an anode side, a cathode side, an anode face on the anode side, and a cathode face on the cathode side. The bipolar plate was a graphite plate (SGL Carbon) having a thickness of 2.5 mm, and having through-bolt holes and port holes that aligned with those of the back plate and current collector plate. The anode face was identical to the anode side of the anode endplate, and included manifold channels, conduit channels, rectangular insets, bridge pieces, a Kapton® polyimide film, an anode catalyst, and a microfluidic channel layer. The cathode face was identical to the cathode side of the cathode endplate, and included serpentine flow channels, conduit channels, rectangular insets, bridge pieces, a gasket, a cathode, and a barrier layer.

The stack was assembled by combining the anode endplate, the electrode assemblies, and the cathode endplate, such that the anode side of the anode endplate was facing the cathode face of an electrode assembly, the cathode side of the cathode endplate was facing the anode face of another electrode assembly, and the electrode assemblies were oriented such that the cathode and anode faces were in contact in pairs. Through-bolts were inserted through the holes and tightened to seal the stack.

### Comparative Example

### Microfluidic Fuel Cell Stack Having Two Flowing Electrolytes

A microfluidic fuel cell stack was assembled as described in Example 1, but was configured for two different electrolyte streams. The back plates each had a third threaded hole in addition to the threaded holes for the plates of Example 1. The third threaded hole for the back plate on the anode side was an inlet port for a second electrolyte, and the third threaded hole for the back plate on the cathode side was an outlet port for the second electrolyte. Each of these holes was fitted with an o-ring. The current collectors each had a third port hole, which aligned with the third threaded hole of the respective back plate. The graphite plates, gaskets and other layers in the stack likewise had a third port hole as needed to ensure that the port holes extended through the stack.

The microfluidic channel layer of the anode endplate was a 3-ply laminate of a porous layer between two Kapton® PYRALUX LF layers. The Kapton® layers were laser machined films as described for Example 1, except that the thickness of each film was 67 micrometers. The porous layer was an 8 micrometer thick polyester track etched layer with 30 nm pores and 6×10⁹ pores/cm² (approximately 2-4% porosity). Thus, the microfluidic channels for each flowing electrolyte stream had a channel height of 67 micrometers.

The anode side of the anode endplate, the cathode side of the cathode endplate, and the anode faces and cathode faces of the electrode assemblies were as described in Example 1, but with some differences in dimensions. For the anode endplate and the anode faces of the electrode assemblies, the anode catalyst area and the corresponding rectangular space in the hot-bonded Kapton® film had a length of 8.2 cm and a width of 5 cm. For the cathode endplate and the cathode faces of the electrode assemblies, the cathode (combined GDE and catalyst) and the corresponding rectangular space in the Kapton® portion of the gasket likewise had a length of 8.2 cm and a width of 5 cm. The barrier layer and the corresponding rectangular space in the ePTFE portion of the gasket each were 8.8 cm long and 5.6 cm wide. The overall gas flow channel areas each had a length of 8 cm and a width of 4.8 cm.

In addition to the dimensional differences, the graphite plates of the cathode endplate and of the cathode faces of the electrode assemblies each included manifold channels, conduit channels, rectangular insets, and bridge pieces, as described for the anode endplate. When the microfluidic channel layer was placed on the cathode endplate or the cathode face of the electrode assembly, the pattern of the microfluidic channel layer overlaid the hydraulic barrier, the manifold channels, and the exposed portions of the conduit channels. The electrolyte inlet and outlet ports were then in fluid connection by way of the microfluidic channels between the two manifolds.

### Example 2

### Comparison of Performance of Fuel Cell Stacks

The microfluidic fuel cell stacks of Example 1 (single-electrolyte stack) and of the Comparative Example (dual-electrolyte stack) were operated under identical conditions. The single-electrolyte stack was provided with a stream of air, and a single stream of an electrolyte/fuel mixture, which was in contact with both the anodes and the cathodes. The dual-electrolyte stack was provided with a stream of air, a stream of an electrolyte/fuel mixture in contact with the anodes, and a stream of electrolyte without fuel in contact with the cathodes.

The air was supplied to each stack at a flow rate of 3 stoich. The electrolyte was 1 M sulfuric acid. The pure fuel was supplied to the electrolyte/fuel mixture at 1.5 stoich, and the mixture was fed to each stack at a flow rate of 120 mL/min. The electrolyte without fuel for the dual-electrolyte stack was 1 M sulfuric acid, and was fed at a flow rate of 120 mL/min. Each stack operated at 60° C., and had a fuel efficiency of approximately 70%. FIG. 17 is a graph of average cell voltage over time for the two fuel cell stacks. Each individual cell produced an electrical current density of 100 mA/cm² at approximately 0.3 Volts per cell.

The single-electrolyte stack had an electrochemical performance comparable to that of the dual-electrolyte stack. The major difference between the two stacks was that the single-electrolyte stack was much simpler to assemble and operate. The single-electrolyte stack had 212 parts to assemble, whereas the dual-fluid stack had 280 parts. The single-electrolyte stack also was easier to seal during assembly, such that there were no external leak points during operation. When the stacks were operated, the single-electrolyte stack required only a single electrolyte reservoir and a single liquid pump, whereas the dual-electrolyte stack required two reservoirs and two pumps.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A fuel cell, comprising:
an anode,
a cathode,
a microfluidic channel contiguous with at least one of the anode and the cathode, and
a single flowing electrolyte;
where the flowing electrolyte passes through the microfluidic channel.

2. The fuel cell of claim 1, where the cathode comprises a gas diffusion electrode.

3. The fuel cell of claim 2, where the oxidant comprises air or oxygen gas.

4. The fuel cell of claim 2, where the cathode further comprises a hydraulic barrier.

5. The fuel cell of claim 2, where the flowing electrolyte comprises a fuel.

6. The fuel cell of claim 5, where the anode is in convective contact with the fuel.

7. The fuel cell of claim 1, where the anode comprises a gas diffusion electrode.

8. The fuel cell of claim 7, where the fuel comprises hydrogen gas or methanol gas.

9. The fuel cell of claim 7, where the anode further comprises a hydraulic barrier.

10. The fuel cell of claim 7, where the flowing electrolyte comprises an oxidant.

11. (canceled)

12. The fuel cell of claim 1, further comprising a stationary electrolyte between the anode and the cathode.

13-15. (canceled)

16. The fuel cell of claim 1, where the microfluidic channel is contiguous with both the anode and the cathode.

17-20. (canceled)

21. The fuel cell of claim 1, where
the microfluidic channel is contiguous with the anode, but not with the cathode,
the flowing electrolyte comprises a fuel, and
the cathode comprises a gas diffusion electrode;
the cell further comprising
an oxidant channel in contact with the cathode, and
a stationary electrolyte between the anode and the cathode.

22-24. (canceled)

25. The fuel cell of claim 1, where
the microfluidic channel is contiguous with the cathode, but not with the anode,
the flowing electrolyte comprises an oxidant, and
the anode comprises a gas diffusion electrode;
the cell further comprising
a fuel channel in contact with the anode, and
a stationary electrolyte between the anode and the cathode.

26-28. (canceled)

29. A method of generating electricity comprising:
flowing a single electrolyte through a microfluidic channel,
where the microfluidic channel is in a fuel cell comprising an anode and a cathode, and the microfluidic channel is contiguous with at least one of the anode and the cathode;
oxidizing a fuel at the anode; and
reducing an oxidant at the cathode;
where the electrolyte comprises the fuel or the oxidant.

30-32. (canceled)

33. A fuel cell, comprising:
a first electrode,
a second electrode, and
a single flowing electrolyte in contact with at least one of the first and second electrodes;
where ions travel from the first electrode to the second electrode without traversing a membrane, and
where a current density of at least 0.1 mA/cm² is produced.

34-35. (canceled)

36. A fuel cell stack, comprising:
a plurality of fuel cells,
wherein at least one of the fuel cells is the fuel cell of claim 1.

37. A power supply device, comprising the fuel cell of claim 1.

38. An electronic device, comprising the power supply device of claim 37.

39. In a fuel cell comprising a first electrode, a second electrode, and a channel contiguous with at least a portion of the first and the second electrodes; such that when a first liquid is contacted with the first electrode, a second liquid is contacted with the second electrode, and the first and the second liquids flow through the channel, a multistream laminar flow is established between the first and the second liquids, and a current density of at least 0.1 mA/cm² is produced,
the improvement comprising replacing the first and second liquids with a single flowing electrolyte in contact with at least one of the first and second electrodes.
